(19) United States
(12) Patent Application Publication
(10) Pub. No.: US 2025/0001355 A1
(43) Pub. Date: Jan. 2, 2025

(54) SYSTEMS AND METHODS FOR REMOVING SPECIES FROM GAS STREAMS

(71) Applicant: MASSACHUSETTS INSTITUTE OF TECHNOLOGY, Cambridge, MA (US)

(72) Inventors: Kripa K. Varanasi, Lexington, MA (US); Vishnu Jayaprakash, Cambridge, MA (US); Sreedath Panat, Cambridge, MA (US); Simon B. Rufer, Cambridge, MA (US)

(73) Assignee: MASSACHUSETTS INSTITUTE OF TECHNOLOGY, Cambridge, MA (US)

(21) Appl. No.: 18/704,700

(22) PCT Filed: Oct. 27, 2022
(86) PCT No.: PCT/US2022/048105

§ 371 Date: Apr. 25, 2024

Related U.S. Application Data
(60) Provisional application No. 63/273,782, filed on Oct. 29, 2021.

(51) Int. Cl. B01D 53/18; B01D 53/14; B01D 53/62; B01D 53/78; B03C 3/013

(52) U.S. Cl. CPC B01D 53/185; B01D 53/1475; B01D 53/62; B01D 53/78; B03C 3/013; B01D 2252/102; B01D 2257/504; B01D 2258/0283

(57) ABSTRACT

Various embodiments address removal of one or more species from a gas stream by exposing the gas stream to divided portions of a fluid, such as droplets of water or mist, where the fluid, and/or content of the fluid, can absorb or modify the species and thereby remove it at least partially from the gas stream. Removal of CO2 from a combustion exhaust stream is one embodiment.

### RELATED APPLICATIONS

This application claims the benefit of priority under 35 U.S.C. § 119(e) of U.S. Provisional Application No. 63/273,782, filed Oct. 29, 2021, the disclosure of which is incorporated herein by reference in its entirety.

### TECHNICAL FIELD

Systems and methods for reducing the amount of one or more species in a gas stream are generally described, including, for example, reducing the amount of carbon dioxide (CO₂) in a combustion exhaust stream.

### BACKGROUND

Global CO₂ emissions continue to rise and reached 36 gigatonnes (Gt) in 2019, placing an enormous strain on the Earth's climate. It is therefore generally desirable to remove CO₂ from the atmosphere. Post-combustion carbon capture in power plants offers an efficient pathway to reducing anthropomorphic emissions, as capturing the CO₂ produced by a single 500 MW natural gas power plant over a year would be equivalent to eliminating emissions from two hundred thousand cars over the same time span. Post-combustion carbon capture technologies can be classified into three main approaches: (i) chemical; (ii) physical; and (iii) biochemical. Chemical approaches include adsorption, direct or membrane-assisted absorption into a liquid, and chemical looping combustion. Physical approaches include membrane separation, physical absorption, and cryogenic distillation. A variety of biochemical methods utilizing enzymatic and algae-based approaches have also been proposed. Of these methods, chemical absorption into a liquid absorbent is widely considered to be the most promising technology due to the higher efficiencies, lower costs, and techno-economic maturity that it offers.

Conventional chemical absorption plants utilize absorption towers comprising packed bed reactors, which are tall towers filled with a number of packing units. A sorbent solution is provided at the top of the absorption tower and flows down over the surface of the packing units, thereby forming films of liquid that react with the rising flue gas stream. The packing units are designed to enhance the interfacial area and the contact time between the liquid absorbent and the flue gas stream. To capture >90% of the CO₂ released from a power plant (where flue gas flow rates can vary between 100-800 kg/s), packed bed reactors need to be large enough to provide enough area and time for absorption to take place. As a result, absorption towers comprising packed bed reactors are routinely over 10 meters in diameter and over 20 meters in height, contributing to approximately 30% of the overall capital requirements for such carbon capture systems. With prohibitively expensive costs being the primary reason for only 28 large scale carbon capture facilities existing worldwide, reducing the size of these absorption towers would help enhance the practicality of post-combustion carbon capture systems.

### SUMMARY

Systems and methods for reducing the amount of one or more species in a gas stream are generally described, including, for example, reducing the amount of CO₂ in a combustion exhaust stream. The invention is summarized in the content of the independent claims and other claims identified below. The subject matter of the present disclosure involves, in some cases, interrelated products, alternative solutions to a particular problem, and/or a plurality of different uses of one or more systems and/or articles.

In some embodiments, a system for removing a gaseous species from a gas stream is described, the system comprising a gas flow pathway having an inlet for receiving the gas stream and an outlet for releasing the gas stream, wherein the gas stream contains less of the gaseous species at the outlet than is contained in the gas stream at the inlet; a gaseous species absorption zone along the gas flow pathway; a source of a liquid mist configured to introduce the liquid mist into the gaseous species absorption zone, wherein the gaseous species absorption zone is configured to expose the liquid mist to the gas stream under conditions that facilitate transfer of at least some of the gaseous species from the gas stream to the liquid mist; and an electrostatic separation zone along the gas flow pathway, fluidly connected to the gaseous species absorption zone and configured to electrostatically separate at least some of the liquid mist from the gas stream.

In certain embodiments, a system for removing a gaseous species from a gas stream comprises a gas flow pathway having an inlet for receiving the gas stream and an outlet for releasing the gas stream, wherein the gas stream contains less of the gaseous species at the outlet than is contained in the gas stream at the inlet; a gaseous species absorption zone along the gas flow pathway; a source of a liquid mist configured to introduce the liquid mist into the gaseous species absorption zone, wherein the gaseous species absorption zone is configured to expose the liquid mist to the gas stream under conditions that facilitate transfer of at least some of the gaseous species from the gas stream to the liquid mist, wherein the liquid mist comprises a plurality of droplets, and wherein each droplet of the plurality of droplets has a maximum characteristic dimension less than or equal to 70 micrometers; and a separation zone along the gas flow pathway, fluidly connected to the gas species absorption zone and configured to separate at least some of the liquid mist from the gas stream.

According to some embodiments, a system for removing a gaseous species from a gas stream comprises a gas flow pathway having an inlet for receiving the gas stream and an outlet for releasing the gas stream, wherein the gas stream contains less of the gaseous species at the outlet than is contained in the gas stream at the inlet; a gaseous species absorption zone along the gas flow pathway; and an absorbent associated with the gaseous species absorption zone, wherein the gaseous species absorption zone is configured to expose the absorbent to the gas stream under conditions that facilitate transfer of at least some of the gaseous species from the gas stream to the absorbent, wherein an interfacial area between the absorbent and the gas stream is at least 10 times greater than an interfacial area between a comparative absorbent and a comparative gas stream in an absorption tower comprising a packed bed reactor that is otherwise essentially identical.

According to certain embodiments, a method of removing a gaseous species from a gas stream is described, wherein the method comprises exposing the gas stream containing the gaseous species to a liquid mist, wherein the liquid mist comprises a reactant configured to react with the gaseous species; in a gaseous species absorption zone, carrying out a reaction between the reactant and the gaseous species that results in absorption of at least 50% of the CO₂ from the gas stream by the liquid mist; and in a separation zone fluidly connected to the gaseous absorption zone, separating at least some of the liquid mist from the gas stream.

In some embodiments, a method of removing a gaseous species from a gas stream comprises exposing the gas stream containing the gaseous species to a liquid mist, wherein the liquid mist comprises a reactant configured to react with the gaseous species; and in a gaseous species absorption zone, carrying out a reaction between the reactant and the gaseous species that results in absorption of at least 50% of the gaseous species from the gas stream by the liquid mist, wherein a ratio of a molar amount of the gaseous species absorbed per hour to a volume of the gaseous species absorption zone is at least 5 times greater than the same ratio in an absorption tower comprising a packed bed reactor that is otherwise essentially identical.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 shows, according to some embodiments, a schematic diagram of a system for removing a gaseous species from a gas stream, wherein the system comprises a gaseous species absorption zone and a separation zone;

FIG. 2 shows, according to some embodiments, a schematic diagram of a system for removing a gaseous species from a gas stream, wherein the system comprises a fluidic connection between a gaseous species absorption zone and a separation zone;

FIG. 3 shows, according to some embodiments, a schematic diagram of a plurality of droplets;

FIG. 4 shows, according to some embodiments, a schematic diagram of an electrostatic separation zone;

FIG. 5 shows, according to some embodiments, a schematic diagram of a system for removing a gaseous species from a gas stream, wherein the system comprise a gaseous species sensor;

FIG. 6 shows, according to some embodiments, a schematic diagram of a system for removing a gaseous species from a gas stream, wherein the system comprises a scrubber;

FIG. 7 shows, according to some embodiments, a schematic diagram of a system for removing a gaseous species from a gas stream, wherein the system comprises a stripper;

FIG. 8A shows, according to some embodiments, a schematic diagram of a conventional absorption system;

FIG. 8B shows, according to some embodiments, a schematic diagram of a two-stage, mist-based absorption system;

FIG. 8C shows, according to some embodiments, the calculated CO₂ capture efficiency for mist-based CO₂ capture as a function of absorber length and droplet size;

FIG. 8D shows, according to some embodiments, the calculated mist capture efficiency for an electrostatic demister unit as a function of length for different average mist droplet diameters;

FIG. 9A shows, according to some embodiments, a schematic diagram of a scaled down, two-stage, mist-based absorption system;

FIG. 9B shows, according to some embodiments, a histogram of droplet parameters produced by a misting unit;

FIG. 10A shows, according to some embodiments, CO₂ capture efficiency plotted as a function of time;

FIG. 10B shows, according to some embodiments, a comparison of normalized gas flux of the experimental setup and industrial systems;

FIG. 10C shows, according to some embodiments, CO₂ concentration as a function of time;

FIG. 10D shows, according to some embodiments, CO₂ capture efficiency as a function of time for different concentrations of potassium hydroxide (KOH);

FIG. 11A shows, according to some embodiments, a schematic diagram of the mist capture unit with no corona discharge;

FIG. 11B shows, according to some embodiments, a schematic diagram of the mist capture unit with corona discharge;

FIG. 11C shows, according to some embodiments, a digital photograph of the exit of the demisting unit under no corona discharge;

FIG. 11D shows, according to some embodiments, a digital photograph of the exit of the demisting unit under corona discharge;

FIG. 11E shows, according to some embodiments, the mist capture efficiency as a function of gas flow rate and applied voltage;

FIG. 12 shows, according to some embodiments, a capital expenditure (CAPEX) split for conventional CO₂ capture systems with absorption columns as a function of CO₂ concentration;

FIG. 13 shows, according to some embodiments, a schematic diagram of the flow stream in a conventional CO₂ capture system;

FIG. 14 shows, according to some embodiments, a schematic diagram of the flow stream in a two-stage, mist-based system;

FIG. 15 shows, according to some embodiments, the enhancement in surface area to volume ratio for mist droplets compared to falling drops from spray towers or a thin film flowing over a packed bed in absorption towers;

FIG. 16 shows, according to some embodiments, a microscopic image of mist droplets entrained along with the gas flow;

FIG. 17 shows, according to some embodiments, mist size droplet diamater distribution;

FIG. 18 shows, according to some embodiments, a schematic diagram of a mist droplet surrounded by flue gas;

FIG. 19 shows, according to some embodiments, the change in pH of deionized (DI) water collected on mesh;

FIG. 20 shows, according to some embodiments, a schematic diagram of space charge injection showing droplet charging and redirection towards the collector electrode;

FIG. 21A shows, according to some embodiments, an image of mist droplets flowing along with the gas flow before applying space charge injection;

FIG. 21B shows, according to some embodiments, an image of mist droplets collected on the mesh collector electrode after applying space charge injection;

FIG. 22A shows, according to some embodiments, an image of mist droplets exiting along with the gas flow from a cylindrical chamber before applying an electric field; and

FIG. 22B shows, according to some embodiments, an image of mist droplets being captured inside the cylindrical chamber after applying an electric field.

### DETAILED DESCRIPTION

Systems and methods for reducing the amount of one or more species in a gas stream are generally described, including, for example, reducing the amount of CO₂ in a combustion exhaust stream. Any of a variety of species can be removed from the gas stream, including, for example, one or more gases and/or one or more particulates. In some embodiments, examples of gases to be removed from the gas stream include greenhouse gases such as CO₂, methane (CH₄), nitrous oxide (N₂O), ozone (O₃), fluorinated gases, and/or combinations thereof. In much of the disclosure below, CO₂ removal from a combustion exhaust stream is discussed and exemplified, but it is to be understood that this disclosure enables those of ordinary skill in the art, by generally following the teachings discussed herein, to remove not only CO₂ from a combustion exhaust stream, but also other species from other gas streams using the same or similar techniques.

In some embodiments, an absorption system comprising one or more spray towers can be used, or can be modified to be much improved as compared to conventional absorption systems comprising spray towers. In conventional spray towers, droplets of an absorbent (e.g., an absorbent liquid) are exposed to a gas stream (e.g., flue gas) such that the droplets absorb one or more species (e.g., CO₂) from the gas stream. After absorbing the one or more species, the droplets are collected at the bottom of the spray tower (e.g., via gravity).

In absorption systems, the interfacial area between the absorbent and the gas stream is generally defined as the surface area of contact between the absorbent and the gas stream.

Equation 1 demonstrates the enhancement to the interfacial area afforded by droplets in comparison to liquid films in absorption towers comprising packed bed reactors, which are utilized in conventional chemical absorption plants.

$$\frac{{A}_{p}}{V} = \frac{1}{t} ; \frac{{A}_{d}}{V} = \frac{N 4 π {R}^{2}}{N \frac{4}{3} π {R}^{3}} = \frac{3}{R} ; \frac{{A}_{d}}{{A}_{p}} = \frac{3 t}{R} = \frac{6 t}{D} \qquad ( Eq . 1 )$$

In Equation 1, Aₚ is the area of the packed bed, Vis the volume of the liquid absorbent, t is the thickness of the liquid film in the packed bed, A_{d} is the area of the droplets that would make up the same volume of absorbent, and R and D are the droplet radius and diameter, respectively. As seen from Equation 1, for the same characteristic length, droplets offer a significantly higher interfacial area than liquid films used in packed bed reactors. Despite this advantage, however, some conventional spray towers result in lower CO₂ capture efficiencies in practice as compared to packed bed reactors. In some cases, for example, there can be droplet loss to the walls of the spray tower, which reduces the overall CO₂ capture efficiency of the absorption system.

Conventional spray towers are counterflow systems and thus rely on gravity to collect the absorbent droplets. The droplets cannot be smaller than a few hundred micrometers as they could be entrained by the gas stream and escape through the exhaust outlet of the absorption system. While passive demisters may be employed in conventional spray towers, they tend to introduce unfavorable back pressures to the exhaust stream and consistently fail at high liquid loading rates. Furthermore, droplets that are too large have slower reaction rates and fall faster through the spray tower. The benefits associated with high interfacial areas afforded by droplets therefore cannot be fully exploited in conventional spray towers.

The inventors have realized and appreciated that a two-stage, mist-based absorption can efficiently remove one or more target gaseous species (e.g., CO₂) from a gas stream (e.g., a combustion exhaust stream). In certain embodiments, the configuration of the system advantageously increases the interfacial area between an absorbent and a gas stream as compared to, for example, conventional absorption systems comprising one or more packed bed reactors, while also decreasing the overall size of the system without any penalty to absorption efficiency. According to some embodiments, during the first stage (e.g., the absorption stage), an absorbent in the form of a liquid mist is exposed to a gas stream containing one or more target gaseous species such that the liquid mist absorbs the one or more target gaseous species. In certain embodiments, during the second stage (e.g., the separation stage), an electrostatic arrangement is utilized to charge the liquid mist via an electrical force that drives the liquid mist to a collector, thereby separating the liquid mist and absorbed target gaseous species from the gas stream.

In some embodiments, a liquid mist is described, wherein the liquid mist is configured to absorb a gaseous species (e.g., CO₂) from a gas stream (e.g., a combustion exhaust stream) in a gaseous species absorption zone, thereby removing the gaseous species at least in part from the gas stream. In certain embodiments, the liquid mist comprises a reactant and/or catalyst (e.g., an absorbent) that is configured to absorb the gaseous species (e.g., via dissolution). In some embodiments, the reactant and/or catalyst (e.g., absorbent) causes and/or facilitates a reaction of the gaseous species, thereby changing (e.g., chemically changing) the gaseous species and/or removing the gaseous species at least in part from the gas stream.

According to some embodiments, the liquid mist comprises droplets with sizes (e.g., maximum diameters) that are sufficiently small to provide a high surface area of contact (e.g., an interfacial area) with the gas stream to facilitate more effective and efficient removal and/or reaction of one or more gaseous species from the gas stream as compared to, for example, conventional absorption towers and/or spray towers. In certain embodiments, due to the small average size of the droplets, the liquid mist may become entrained in the gas stream. In some such embodiments, the liquid mist may be separated from the gas stream as described herein in greater detail.

In certain embodiments, which can be used alone or in combination with other aspects of this disclosure, the liquid mist may be separated from the gas stream electrostatically and/or physically. In some embodiments, for example, an electrostatic separation zone is used to separate at least some of the liquid mist from the gas stream after the liquid mist absorbs one or more species from the gas stream. According to some embodiments, the electrostatic separation zone may comprise an electrostatic component that is configured to attract and/or direct at least some of the liquid mist to a collection zone, where the liquid mist can be collected and optionally recycled, for example, for further use in the absorption system. In certain embodiments, physical separation of the liquid mist from the gas stream generally involves allowing the gas stream comprising the liquid mist to encounter a surface (e.g., a mesh and/or porous surface) at which the liquid mist is absorbed and/or adsorbed.

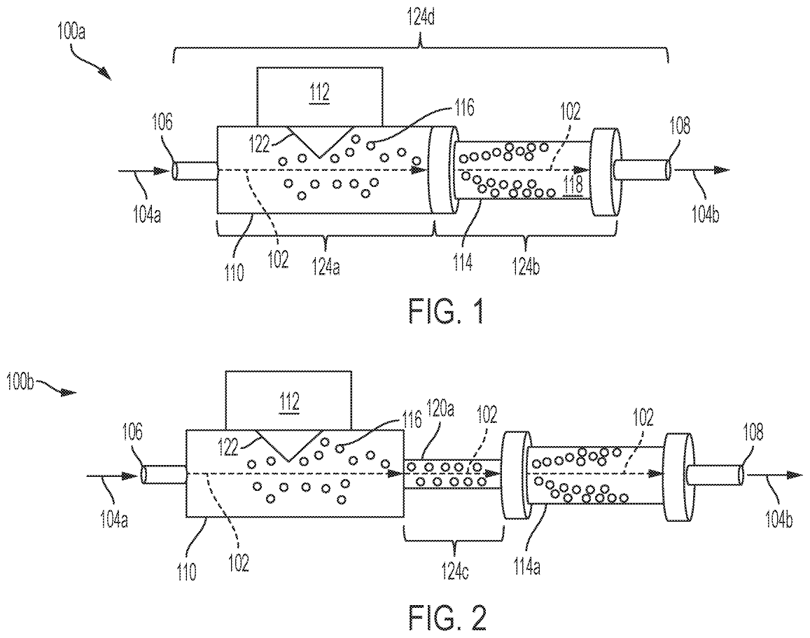

According to some embodiments, a system for removing a gaseous species from a gas stream (e.g., an absorption system) is described herein. FIG. 1 shows, according to some embodiments, a schematic diagram of system 100a for removing a gaseous species from gas stream 104.

In certain embodiments, the system comprises a gas flow pathway. Referring to FIG. 1, for example, system 100a shows one example of an arrangement including gas flow pathway 102, which is denoted in the figures by dotted arrows. In some embodiments, the gas flow pathway has an inlet for receiving the gas stream. As shown in the embodiment illustrated in FIG. 1, for example, gas flow pathway 102 has inlet 106 for receiving gas stream 104a. In certain embodiments, the gas flow pathway also has an outlet for releasing the gas stream. As shown in the embodiment illustrated in FIG. 1, for example, gas flow pathway 102 has outlet 108 for releasing gas stream 104b. According to some embodiments, the inlet and/or the outlet may be associated with one or more blowers and/or fans to facilitate the flow of the gas stream along the gas flow pathway.

Any of a variety of suitable arrangements for the gas flow pathway can be provided. Those of ordinary skill in the art will recognize, based on the totality of this disclosure, that the gas flow pathway can be constructed in any way so as to direct some or all of a gas steam introduced at the inlet toward and through the outlet. The gas flow pathway can be constructed from any of a variety of suitable materials, including, for example, in many cases standard materials that are used in similar gas treatment processes and/or materials chosen that are resistant to corrosion by a gas in the gas flow pathway, if desired.

The gas stream may have any of a variety of suitable flow velocities (measured in m/s) or per-area gas fluxes (measured in (m³/s)/(m²)). In certain embodiments, for example, the gas stream has a flow velocity greater than or equal to 0.1 m/s, greater than or equal to 0.5 m/s, greater than or equal to 1 m/s, greater than or equal to 2 m/s, greater than or equal to 3 m/s, greater than or equal to 4 m/s, greater than or equal to 5 m/s, greater than or equal to 6 m/s, greater than or equal to 7 m/s, greater than or equal to 8 m/s, or greater than or equal to 9 m/s. In some embodiments, the gas stream has a flow velocity less than or equal to 10 m/s. less than or equal to 9 m/s, less than or equal to 8 m/s, less than or equal to 7 m/s, less than or equal to 6 m/s, less than or equal to 5 m/s, less than or equal to 4 m/s, less than or equal to 4 m/s, less than or equal to 3 m/s, less than or equal to 2 m/s, less than or equal to 1 m/s, or less than or equal to 0.5 m/s. Combinations of the above recited ranges are possible (e.g., the gas stream has a flow velocity greater than or equal to 0.1 m/s and less than or equal to 10 m/s. the gas stream has a flow velocity greater than or equal to 4 m/s and less than or equal to 5 m/s). Other ranges are also possible.

According to certain embodiments, an overall gas stream pressure drop may occur between the inlet of the gas flow pathway and the outlet of the gas flow pathway. Referring to FIG. 1, for example, an overall gas stream pressure drop may occur between inlet 106 of gas flow pathway 102 and outlet 108 of gas flow pathway 102.

The overall gas stream pressure drop between the inlet of the gas flow pathway and the outlet of the gas flow pathway may be any of a variety of suitable values. In some embodiments, for example, the overall gas stream pressure drop between the inlet of the gas flow pathway and the outlet of the gas flow pathway may be greater than or equal to 1×10⁻⁵ Pa, greater than or equal to 1×10⁻⁴ Pa, greater than or equal to 1×10⁻³ Pa, greater than or equal to 1×10⁻² Pa, greater than or equal to 1×10⁻¹ Pa, greater than or equal to 1 Pa, greater than or equal to 10 Pa, greater than or equal to 100 Pa, or greater than or equal to 1000 Pa. In some embodiments, the overall gas stream pressure drop between the inlet of the gas flow pathway and the outlet of the gas flow pathway may be less than or equal to 10000 Pa, less than or equal to 1000 Pa, less than or equal to 100 Pa, less than or equal to 10 Pa, less than or equal to 1 Pa, less than or equal to 1×10⁻¹ Pa, less than or equal to 1×10⁻² Pa, less than or equal to 1×10⁻³ Pa, or less than or equal to 1×10⁻⁴ Pa. Combinations of the above recited ranges are possible (e.g., the overall gas stream pressure drop between the inlet of the gas flow pathway and the outlet of the gas flow pathway may be greater than or equal to 1×10⁻⁴ Pa and less than or equal to 10000 Pa, the overall gas stream pressure drop between the inlet of the gas flow pathway and the outlet of the gas flow pathway may be greater than or equal to 1×10⁻¹ Pa and less than or equal to 1 Pa). Other ranges are also possible. In certain embodiments, the overall gas stream pressure drop between the inlet of the gas flow pathway and the outlet of the gas flow pathway may be determined by measuring the difference in the pressure of the gas stream between the inlet of the gas flow pathway and the outlet of the gas flow pathway (e.g., using a pressure sensor and/or pressure gauge).

According to certain embodiments, the overall gas stream pressure drop is less than a comparative gas stream pressure drop in conventional absorption towers comprising one or more packed bed reactors. In some embodiments, for example, there is less resistance to gas flow in the gas flow pathway as compared to, for example, conventional absorption towers comprising one or more packed bed reactors. A lower overall gas stream pressure drop may advantageously reduce costs associated with one or more pressure sources and/or pumps configured to facilitate the flow of the gas stream along the gas flow pathway.

According to certain embodiments, the gas stream contains less of the gaseous species at the outlet of the gas flow pathway than is contained in the gas stream at the inlet of the gas flow pathway. Referring to FIG. 1, for example, gas stream 104b contains less of the gaseous species at outlet 108 of gas flow pathway 102 than is contained in gas stream 104a at inlet 106 of gas flow pathway 102.

In some embodiments, the gas stream contains greater than or equal to 10% less, greater than or equal to 20% less, greater than or equal to 30% less, greater than or equal to 40% less, greater than or equal to 50% less, greater than or equal to 60% less, greater than or equal to 70% less, greater than or equal to 80% less, or greater than or equal to 90% less of the gaseous species at the outlet of the gas flow pathway than is contained in the gas stream at the inlet of the gas flow pathway. In certain embodiments, the gas stream contains less than or equal to 100% less, less than or equal to 90% less, less than or equal to 80% less, less than or equal to 70% less, less than or equal to 60% less, less than or equal to 50% less, less than or equal to 40% less, less than or equal to 30% less, or less than or equal to 20% less of the gaseous species at the outlet of the gas flow pathway than is contained in the gas stream at the inlet of the gas flow pathway. Combinations of the above recited ranges are possible (e.g., the gas stream contains greater than or equal to 10% less and less than or equal to 100% less of the gaseous species at the outlet of the gas flow pathway than is contained in the gas stream at the inlet of the gas flow pathway, the gas stream contains greater than or equal to 60% less and less than or equal to 80% less of the gaseous species at the outlet of the gas flow pathway than is contained in the gas stream at the inlet of the gas flow pathway). Other ranges are also possible. In certain embodiments, the amount of the gaseous species in the gas stream (e.g., at the inlet, at the outlet) may be measured by gas chromatography and/or a gaseous species sensor (e.g., a CO₂ sensor).

According to some embodiments, the system comprises a gaseous species absorption zone. Referring to FIG. 1, for example, system 100a comprises gaseous species absorption zone 110. In certain embodiments, and as explained in further detail below, the gaseous species absorption zone is configured to expose an absorbent to the gas stream such that the absorbent absorbs a gaseous species from the gas stream.

The gaseous species absorption zone may, in some embodiments, be positioned along the gas flow pathway. As shown in FIG. 1, for example, gaseous species absorption zone 110 is positioned along gas flow pathway 102. In some embodiments, the gaseous species absorption zone is fluidly connected to the inlet of the gas flow pathway. As shown in FIG. 1, for example, gaseous species absorption zone 110 is fluidly connected to inlet 106 of gas flow pathway 102.

According to some embodiments, the gaseous species absorption zone may be configured as a tube, column, and/or cylinder. Configuring the gaseous species absorption zone as a tube, column, and/or cylinder may advantageously facilitate the flow of the gas stream along the gas flow pathway through the gaseous species absorption zone. Other configurations for the gaseous species absorption zone are also possible, however, as the disclosure is not meant to be limiting in this regard, including, for example, a cube, prism, and/or cone configuration.

The gaseous species absorption zone may have any of a variety of suitable dimensions. In some embodiments, for example, the gaseous species absorption zone has a length that is sufficiently long enough to provide an advantageously high interfacial area between the absorbent and the gas stream. Referring to FIG. 1, for example, gaseous absorption zone 110 has length 124a.

The gaseous species absorption zone may have any of a variety of suitable lengths. In some embodiments, for example, the length of the gaseous species absorption zone is greater than or equal to 10 centimeters, greater than or equal to 50 centimeters, greater than or equal to 1 meter, greater than or equal to 2 meters, greater than or equal to 3 meters, greater than or equal to 4 meters, greater than or equal to 5 meters, greater than or equal to 10 meters, or greater than or equal to 20 meters. In certain embodiments, the length of the gaseous species absorption zone is less than or equal to 30 meters, less than or equal to 20 meters, less than or equal to 10 meters, less than or equal to 5 meters, less than or equal to 4 meters, less than or equal to 3 meters, less than or equal to 2 meters, less than or equal to 1 meter, or less than or equal to 50 centimeters. Combinations of the above recited ranges are possible (e.g., the length of the gaseous species absorption zone is greater than or equal to 10 centimeters and less than or equal to 30 meters, the length of the gaseous species absorption zone is greater than or equal to 3 meters and less than or equal to 4 meters). Other ranges are also possible.

In certain embodiments wherein the gaseous absorption zone is configured as a tube, column, and/or cylinder, the gaseous absorption zone may have any of a variety of suitable diameters. In certain embodiments, for example, the gaseous species absorption zone has a diameter greater than or equal to 1 centimeter, greater than or equal to 50 centimeters, greater than or equal to 1 meter, greater than or equal to 5 meters, or greater than or equal to 10 meters. In some embodiments, the gaseous species absorption zone has a diameter less than or equal to 20 meters, less than or equal to 10 meters, less than or equal to 5 meters, less than or equal to 1 meter, or less than or equal to 50 centimeters. Combinations of the above recited ranges are possible (e.g., the gaseous species absorption zone has a diameter greater than or equal to 1 centimeter and less than or equal to 20 meters, the gaseous species absorption zone has a diameter greater than or equal to 1 meter and less than or equal to 5 meters). Other ranges are also possible.

The gaseous species absorption zone may comprise any of a variety of suitable materials. According to some embodiments, for example, the gaseous species absorption zone may comprise a metal, a metal alloy, a clad material, a ceramic, a plastic, a carbon-based material, and/or combinations thereof. Other materials are also possible. In certain embodiments, the gaseous species absorption zone material may be at least partially coated. For example, in some embodiments, the gaseous species absorption zone material may be coated with a corrosion resistant material (e.g., a plastic coated with a corrosion resistant metal or alloy).

In certain embodiments, the gaseous species absorption zone is a non-packed bed reactor. According to some embodiments, for example, the gaseous species absorption zone does not comprise a packed bed reactor.

According to some embodiments, the gaseous species absorption zone may comprise any of a variety of suitable fluidic components to enhance the interaction between the gas stream and the absorbent. In certain embodiments, for example, the gaseous species absorption zone may comprise one or more secondary circulation flow promoters, flow obstruction promoters, and/or turbulence promoters configured to maximize the interaction between the gas stream and the absorbent.

The gascous species absorption zone may have any of a variety of suitable temperatures and/or pressures to facilitate absorption of the gaseous species from the gas stream by the absorbent. In some embodiments, for example, increased temperatures (e.g., relative to room temperature) may enhance dissolution of the gaseous species into the absorbent and/or reaction between the absorbent and the gaseous species, but may also contribute to faster rates of evaporation of the absorbent. In certain embodiments, an increased overall pressure of the gaseous species absorption zone may enhance dissolution of the gaseous species into the absorbent and/or reaction between the absorbent and the gaseous species, but may also be unpractical from an economic standpoint. Accordingly, in certain embodiments, the temperature and/or overall pressure of the gaseous species absorption zone may be tuned and/or chosen by a user depending on the absorbent, target gaseous species, and/or the components of the gas stream to facilitate adsorption of the gaseous species from the gas stream while avoiding evaporation of the absorbent and/or increased costs.

According to certain embodiments, the system comprises an absorbent. Referring to FIG. 1, for example, system 100a comprises absorbent 116. Absorbent 116 may, in some embodiments, be associated with gascous species absorption zone 110. In certain embodiments, for example, gaseous species absorption zone 110 is configured to expose absorbent 116 to gas stream 104 (e.g., along gaseous flow pathway 102). According to some embodiments, absorbent 116 is exposed to gas stream 104 (e.g., in gaseous species absorption zone 110) under conditions that facilitate transfer of at least some of the gaseous species from gas stream 104 to absorbent 116. Suitable conditions that facilitate transfer of at least some of the gaseous species from the gas stream to the absorbent, including, for example, concentration and/or size of the absorbent, temperature, pressure, and/or fluidic conditions, are explained herein in further detail.

According to some embodiments, the absorbent (e.g., liquid absorbent) may be configured such that the gaseous species dissolves in the absorbent. In some embodiments, the absorbent may be a reactant and/or catalyst that causes and/or facilitates a reaction of the gaseous species, thereby changing (e.g., chemically changing) the gaseous species and/or removing the gaseous species at least in part from the gas stream. In some embodiments, for example, the absorbent may react (e.g., chemically react) with the gaseous species in the gas stream. In some such embodiments, the absorbent may interact with the gaseous species and remove the gaseous species from the gas stream. In certain embodiments, the interaction between the absorbent and the gaseous species is one or more bonding interactions (e.g., chemical bonding interactions). Any of a variety of suitable bonding interactions between the absorbent and the gaseous species are possible, including, for example, covalent bonds, ionic bonds, dipole-dipole interactions, van der Waals interactions, London dispersion forces, and/or hydrogen bonds.

Any of a variety of suitable absorbents may be employed. According to certain embodiments, virtually any absorbent may be used in the system described herein. In some embodiments, the absorbent comprises an amine-containing compound (e.g., monoethanolamine (MEA), 2-amino-2-methyl-1-propanol (AMP)), a hydroxide (e.g., potassium hydroxide (KOH)), ammonia, a quinone, an amino acid, an ionic liquid, and/or combinations thereof. Other absorbents are also possible.

In certain embodiments, the absorbent may be in liquid form (e.g., the absorbent exists as a liquid at standard temperature and pressure). The absorbent may, in some embodiments, comprise a mixture (e.g., an absorbent mixture). In some embodiments, for example, the absorbent mixture comprises a reactant (e.g., any of the absorbents described above) dissolved and/or dispersed in a liquid (e.g., water).

The absorbent mixture may comprise the reactant in any of a variety of suitable amounts. In certain embodiments, for example, the absorbent mixture comprises the reactant in an amount greater than or equal to 5 weight percent (wt. %), greater than or equal to 10 wt. %, greater than or equal to 20 wt. %, greater than or equal to 30 wt. %, or greater than or equal to 40 wt. % versus the total weight of the absorbent mixture. In some embodiments, the absorbent mixture comprises the reactant in an amount less than or equal to 50 wt. %, less than or equal to 40 wt. %, less than or equal to 30 wt. %, less than or equal to 20 wt. %, or less than or equal to 10 wt. % versus the total weight of the absorbent mixture. Combinations of the above recited ranges are possible (e.g., the absorbent mixture comprises the reactant in an amount greater than or equal to 5 wt. % and less than or equal to 50 wt. % versus the total weight of the absorbent mixture, the absorbent mixture comprises the reactant in an amount greater than or equal to 20 wt. % and less than or equal to 30 wt. % versus the total weight of the absorbent mixture). Other ranges are also possible.

In certain embodiments, the absorbent mixture may comprise one or more additives. In certain embodiments, for example, the absorbent mixture comprises nanoparticles configured to adsorb the gaseous species, thereby enhancing the removal efficiency of absorbent mixture towards the gaseous species. The nanoparticles may, in some embodiments, be optionally functionalized with one or more functional groups configured to adsorb the gaseous species. Other additives are also possible, including, for example, surfactants.

According to certain embodiments, the system may comprise an adsorbent (e.g., in addition to or instead of the absorbent). The adsorbent may, in some embodiments, be configured to adsorb the gaseous species from the gas stream. Suitable adsorbents include, for example, a nanofluid. In certain embodiments, the nanofluid comprises a fluid comprising nanoparticles. The nanoparticles may, in some embodiments, be optionally functionalized with one or more functional groups configured to adsorb the gaseous species.

In some embodiments, the absorbent is in the form of a liquid mist. Referring to FIG. 1, for example, absorbent 116 may be in the form of a liquid mist. In certain embodiments, the system may comprise a source of liquid mist that is configured to convert an absorbent (e.g., a liquid absorbent) and/or an absorbent mixture (e.g., a reactant dissolved and/or dispersed in a liquid) to a liquid mist. As shown in FIG. 1, for example, system 100a comprises source of liquid mist 112. According to certain embodiments, source of liquid mist 112 is configured to introduce the liquid mist into gaseous species absorption zone 110 such that the liquid mist is exposed to gas stream 104 (e.g., along gas flow pathway 102) under conditions that facilitate transfer of at least some of the gaseous species from gas stream 104 to the liquid mist. In certain embodiments, for example, source of liquid mist 112 is fluidly connected to dispenser 122, wherein dispenser 122 is configured to dispense the liquid mist into gaseous species absorption zone 110. In some non-limiting embodiments, for example, the dispenser may be a nozzle that is configured to spray the liquid mist into the gaseous species absorption zone. Other dispensers are also possible, however, as the disclosure is not meant to be limiting in this regard.

The source of liquid mist may be any of a variety of suitable liquid mist sources. In some embodiments, for example, the source of liquid mist is an ultrasonic mist and/or fog unit, a mist and/or fog generator, a mist and/or fog fan, a mist and/or fog sprayer, and/or an atomizer. Other sources of liquid mist are also possible.

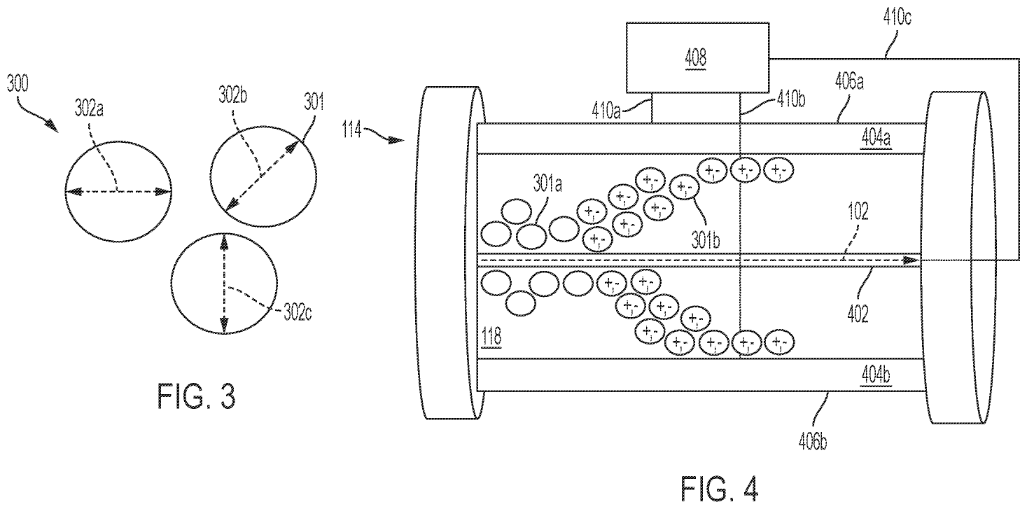

In certain embodiments, the liquid mist comprises a plurality of droplets (e.g., liquid droplets). FIG. 3 shows, according to some embodiments, a schematic diagram of plurality of droplets 300.

Each droplet of the plurality of droplets may have any of a variety of suitable shapes. In some embodiments, for example, and as shown in FIG. 3, each droplet 301 of the plurality of droplets 300 is substantially spherical. In other embodiments, at least a portion of the plurality of droplets are substantially non-spherical, as the disclosure is not meant to be limiting in this regard.

Each droplet of the plurality of droplets may have any of a variety of suitable sizes. In some embodiments, each droplet of the plurality of droplets has a maximum characteristic dimension (e.g., a maximum diameter). Referring to FIG. 3, for example, each droplet 301 of plurality of droplets 300 has a maximum characteristic dimension 302 (e.g., a maximum diameter). In certain embodiments, the maximum characteristic dimension of each droplet of the plurality of droplets may be sufficiently small to provide an increased interfacial surface area between the liquid mist and the gas stream as compared to, for example, conventional absorption towers comprising one or more packed bed reactors.

The maximum characteristic dimension of each droplet of the plurality of droplets may be any of a variety of suitable values. According to certain embodiments, each droplet of the plurality of droplets may have a maximum characteristic dimension (e.g., maximum diameter) greater than or equal to 0.1 micrometers, greater than or equal to 0.5 micrometers, greater than or equal to 1 micrometer, greater than or equal to 10 micrometers, greater than or equal to 20 micrometers, greater than or equal to 30 micrometers, greater than or equal to 40 micrometers, greater than or equal to 50 micrometers, greater than or equal to 60 micrometers, greater than or equal to 70 micrometers, greater than or equal to 80 micrometers, or greater than or equal to 90 micrometers. In certain embodiments, each droplet of the plurality of droplets has a maximum characteristic dimension (e.g., a maximum diameter) less than or equal to 100 micrometers, less than or equal to 90 micrometers, less than or equal to 80 micrometers, less than or equal to 70 micrometers, less than or equal to 60 micrometers, less than or equal to 50 micrometers, less than or equal to 40 micrometers, less than or equal to 30 micrometers, less than or equal to 20 micrometers, less than or equal to 10 micrometers, less than or equal to 1 micrometer, or less than or equal to 0.5 micrometers. Combinations of the above recited ranges are possible (e.g., each droplet of the plurality of droplets has a maximum characteristic dimension greater than or equal to 0.1 micrometers and less than or equal to 100 micrometers, each droplet of the plurality of droplets has a maximum characteristic dimension greater than or equal to 40 micrometers and less than or equal to 60 micrometers). Other ranges are also possible. In certain embodiments, the maximum characteristic dimension (e.g., maximum diameter) of the droplets may be determined by scanning electron microscopy (SEM) and/or transmission electron microscopy (TEM).

According to some embodiments, as would be recognizable by a person of ordinary skill in the art, the plurality of droplets may have a size distribution such that each droplet of the plurality of droplets has a maximum characteristic dimension between greater than or equal to 0.1 micrometer and less than or equal to 100 micrometers. In some embodiments, at least some of the droplets of the plurality of droplets having a size distribution may have a maximum characteristic dimension (e.g., a maximum diameter) larger and/or smaller than the maximum characteristic dimensions listed above.

According to certain embodiments, the average dimension (e.g., average diameter) of the plurality of droplets may be greater than or equal to 0.1 micrometers, greater than or equal to 0.5 micrometers, greater than or equal to 1 micrometer, greater than or equal to 10 micrometers, greater than or equal to 20 micrometers, greater than or equal to 30 micrometers, greater than or equal to 40 micrometers, greater than or equal to 50 micrometers, greater than or equal to 60 micrometers, greater than or equal to 70 micrometers, greater than or equal to 80 micrometers, or greater than or equal to 90 micrometers. In some embodiments, the average dimension (e.g., average diameter) of the plurality of droplets may be less than or equal to 100 micrometers, less than or equal to 90 micrometers, less than or equal to 80 micrometers, less than or equal to 70 micrometers, less than or equal to 60 micrometers, less than or equal to 50 micrometers, less than or equal to 40 micrometers, less than or equal to 30 micrometers, less than or equal to 20 micrometers, less than or equal to 10 micrometers, less than or equal to 1 micrometer, or less than or equal to 0.5 micrometers. Combinations of the above recited ranges are possible (e.g., the average dimension of the plurality of droplets is greater than or equal to 0.1 micrometers and less than or equal to 100 micrometers, the average dimension of the plurality of droplets is greater than or equal to 40 micrometers and less than or equal to 60 micrometers). Other ranges are also possible. In certain embodiments, the average dimension of the plurality of droplets may be determined by SEM and/or TEM.

According to certain embodiments, due to the size (e.g., maximum characteristic dimension, average dimension) of the droplets of liquid mist, the droplets may be entrained in the gas stream during the absorption stage. In some embodiments, and as explained in further detail herein, the droplets of liquid mist may be separated from the gas stream during the separation stage.

According to certain embodiments, the system may have a high interfacial area between the absorbent and the gas stream in the gaseous species absorption zone as compared to, for example, conventional absorption towers comprising one or more packed bed reactors. A high interfacial area between the absorbent and the gas stream advantageously provides higher absorption efficiencies of target species within the gas stream due to the surface area contact between the absorbent and the gas stream.

In some embodiments, the interfacial area between the absorbent and the gas stream in the gaseous species absorption zone is at least 10 times greater, at least 50 times greater, at least 100 times greater, at least 200 times greater, at least 300 times greater, at least 400 times greater, at least 500 times greater, at least 600 times greater, at least 700 times greater, at least 800 times greater, or at least 900 times greater than an interfacial area between a comparative absorbent and a comparative gas stream in an absorption tower comprising one or more packed bed reactors that is otherwise essentially identical. In certain embodiments, the interfacial area between the absorbent and the gas stream in the gascous species absorption zone is less than or equal to 1000 times greater, less than or equal to 900 times greater, less than or equal to 800 times greater, less than or equal to 700 times greater, less than or equal to 600 times greater, less than or equal to 500 times greater, less than or equal to 400 times greater, less than or equal to 300 times greater, less than or equal to 200 times greater, less than or equal to 100 times greater, or less than or equal to 50 times greater than an interfacial area between a comparative absorbent and a comparative gas stream in an absorption tower comprising one or more packed bed reactors that is otherwise essentially identical. Combinations of the above recited ranges are possible (e.g., the interfacial area between the absorbent and the gas stream in the gaseous species absorption zone is at least 10 times greater and less than or equal to 1000 times greater than an interfacial area between a comparative absorbent and a comparative gas stream in an absorption tower comprising one or more packed bed reactors that is otherwise essentially identical, the interfacial area between the absorbent and the gas stream in the gaseous species absorption zone is at least 400 times greater and less than or equal to 500 times greater than an interfacial area between a comparative absorbent and a comparative gas stream in an absorption tower comprising one or more packed bed reactors that is otherwise essentially identical). Other ranges are also possible.

According to certain embodiments, the increase in interfacial area as compared to a comparative absorbent and a comparative gas stream in an absorption tower comprising one or more packed bed reactors that is otherwise essentially identical is due to: (i) the sufficiently small size (e.g., maximum characteristic dimension, average dimension) of the droplets of liquid mist; (ii) the sufficiently small size (e.g., length, diameter) of the gaseous species absorption zone; and/or (iii) the tighter packing of droplets in the gaseous species absorption zone as compared to the one or more packed bed reactors in the absorption tower.

According to some embodiments, the system comprises a separation zone. Referring to FIG. 1, for example, system 100a comprises separation zone 114. As explained in further detail below, the separation zone is, in some embodiments, configured to separate at least some of the absorbent (e.g., in the form of a liquid mist) from the gas stream.

The separation zone may, in some embodiments, be positioned along the gas flow pathway. As shown in FIG. 1, for example, separation zone 114 is positioned along gas flow pathway 102 (e.g., upstream from gaseous species absorption zone 110). In certain embodiments, the separation zone is fluidly connected to the gaseous species absorption zone. Referring to FIG. 1, for example, separation zone 114 is fluidly connected to gaseous species absorption zone 110.

In some embodiments, the separation zone is an electrostatic separation zone. Referring to FIG. 1, for example, separation zone 114 may, in some embodiments, be an electrostatic separation zone. In certain embodiments, the electrostatic separation zone comprises an electrostatic component. As shown in FIG. 1, for example, separation zone 114 comprises electrostatic component 118. The electrostatic separation zone may, in some embodiments, be configured to electrostatically separate at least some of the liquid mist from the gas stream. In certain embodiments, for example, the electrostatic separation zone is configured to expose the gas stream comprising the liquid mist to a space charge injection (e.g., corona discharge) from the electrostatic component.

FIG. 4 shows, according to some embodiments, a schematic diagram of an electrostatic separation zone. The electrostatic separation zone may, in some embodiments, comprise an electrostatic component comprising at least one emitter electrode and at least one collector electrode. Referring to FIG. 4, for example, electrostatic separation zone 114 comprises electrostatic component 118 comprising emitter electrode 402 and collector electrodes 404 (e.g., 404a and 404b). In some embodiments, the one or more emitter electrodes may be associated with the gas flow pathway. As shown in FIG. 4, for example, emitter electrode 402 is associated with gas flow pathway 102 such that gas stream flows proximate to emitter electrode 402 along gas glow pathway 102. The one or more collector electrodes may, in certain embodiments, be associated with one or more walls and/or enclosures of the electrostatic component. Referring to FIG. 4, for example, collector electrode 404a is associated with wall and/or enclosure 406a of electrostatic component 118 and collector electrode 404b is associated with wall and/or enclosure 406b of electrostatic component 118.

The at least one emitter electrode may comprise any of a variety of suitable materials. The at least one emitter electrode material may, in some embodiments, be capable of conducting electrons. According to some embodiments, the at least one emitter electrode may be a corrosion resistant material. In certain embodiments, for example, the at least one emitter electrode comprises a metal (e.g., molybdenum, tungsten), a metal oxide, and/or an alloy. The at least one emitter electrode may, in some embodiments, comprise one or more composite materials and/or one or more coatings (e.g., on an external surface of the at least one emitter electrode) to improve the stability and/or lifetime of the at least one emitter electrode. In certain non-limiting embodiments, the emitter electrode is a wire electrode.

The at least one collector electrode may comprise any of a variety of suitable materials. The at least one collector electrode material may, in some embodiments, be capable of conducting electrons. According to certain embodiments, the at least one collector electrode may be a corrosion resistant material. In some embodiments, for example, the at least one collector electrode comprises a metal, a metal oxide, and/or an alloy. The at least one collector electrode may, in some embodiments, comprise one or more composite materials and/or one or more coatings (e.g., on an external surface of the at least one emitter electrode) to improve the stability and/or lifetime of the at least one collector electrode. In certain non-limiting embodiments, the collector electrode is an annular cylindrical electrode.

In certain embodiments, the at least one emitter electrode is configured to emit a space charge injection (e.g., corona discharge) to the gas stream comprising entrained liquid mist as the gas stream flows along the gas flow pathway. Referring to FIG. 4, for example, emitter electrode 402 is configured to provide an electric field by emitting a space charge injection (e.g., corona discharge) to the gas stream comprising entrained liquid mist as the gas stream flows along gas flow pathway 102. In some embodiments, as a droplet of the plurality of droplets of the liquid mist is exposed to the space charge injection (e.g., corona discharge), the droplet becomes charged (e.g., positively charged, negatively charged). As shown in FIG. 4, for example, as droplet 301a (e.g., uncharged droplet) is exposed to a space charge injection (e.g., corona discharge) from emitter electrode 402, the droplet becomes charged droplet 301b (e.g., a positively charged droplet, a negatively charged droplet). In certain embodiments, for example, the emitter electrode provides an electric field that ionizes the atmosphere surrounding the emitter electrode, which imparts a net charge to each droplet of the plurality of droplets entrained in the gas stream flowing along the gas flow pathway.

According to certain embodiments, the at least one collector electrode is configured to collect a charged droplet after the droplet is exposed to the space charge injection (e.g., corona discharge) from the at least one emitter electrode. As shown in FIG. 4, for example, collector electrodes 404a and 404b are configured to collect charged droplet 301b after the droplet is exposed to the space charge injection (e.g., corona discharge) from emitter electrode 402. In some embodiments, the charged droplets experience an electrostatic force in the direction of the electric field and thus are attracted to and collected by the at least one collector electrode.

According to some embodiments, the one or more collector electrodes of the electrostatic component may be configured with a mesh and/or porous surface. The mesh and/or porous surface of the one or more collector electrodes may, in some embodiments, be configured to absorb and/or adsorb one or more droplets of the liquid mist. In some embodiments, for example, one or more droplets (e.g., charged droplets) of the liquid mist may be absorbed and/or adsorbed by the mesh and/or porous surface of the collector electrode after the droplets are exposed to the space charge injection (e.g., corona discharge).

In certain embodiments, the electrostatic component of the electrostatic separation zone may be associated with a power supply. Referring to FIG. 3, for example, electrostatic component 118 of electrostatic separation zone 114 is associated with power supply 408 (e.g., a high voltage power supply). The power supply may be connected to the at least one emitter electrode and the at least one collector electrode. As shown in FIG. 3, for example, power supply 408 is connected to emitter electrode 402 via connection (e.g., electrical connection) 410c, collector electrode 404a via connection (e.g., electrical connection) 410a, and collector electrode 404b via connection (e.g., electrical connection) 410b.

In certain embodiments, the separation zone comprises one or more surfaces that are configured to absorb and/or adsorb the liquid mist. In some embodiments, for example, the gas stream comprising entrained liquid mist may be flowed directly through a surface (e.g., a mesh and/or porous surface) in the separation zone (e.g., a collector electrode, a non-electrode surface, etc.) that captures at least some of the liquid mist. In other embodiments, the gas stream comprising the entrained liquid mist is flowed proximate a surface (e.g., a mesh and/or porous surface) in the separation zone (e.g., a collector electrode, a non-electrode surface, etc.), but need not pass through the surface. In certain embodiments, for example, a surface may be arranged as an enclosure and/or wall of the separation zone, and the gas stream comprising the entrained liquid mist can be directed at and/or tangential to the enclosure and/or wall such that the entrained liquid mist diffuses proximate the enclosure and/or wall. In one set of embodiments, the gas stream comprising entrained liquid mist is circulated and repeatedly flowed by one or more walls of an enclosure of the separation zone, for example a mesh surface defining an enclosure of the separation zone that is configured to separate the liquid mist from the gas stream.

According to some embodiments, the separation zone may be configured as a tube, column, and/or cylinder. Configuring the separation zone as a tube, column, and/or cylinder may advantageously facilitate the flow of the gas stream along the gas flow pathway through the separation zone. Other configurations for the separation zone are also possible, however, as the disclosure is not meant to be limiting in this regard, including, for example, a cube, prism, and/or cone configuration.

The separation zone may, in some embodiments, have any of a variety of suitable dimensions. Referring to FIG. 1, for example, separation zone 114 has length 124b.

The separation zone may have any of a variety of suitable lengths. In some embodiments, for example, the length of the separation zone is greater than or equal to 10 centimeters, greater than or equal to 50 centimeters, greater than or equal to 1 meter, greater than or equal to 2 meters, greater than or equal to 3 meters, or greater than or equal to 4 meters. In certain embodiments, the length of the separation zone is less than or equal to 5 meters, less than or equal to 4 meters, less than or equal to 3 meters, less than or equal to 2 meters, less than or equal to 1 meter, or less than or equal to 50 centimeters. Combinations of the above recited ranges are possible (e.g., the length of the separation zone is greater than or equal to 10 centimeters and less than or equal to 5 meters, the length of the separation zone is greater than or equal to 1 meter and less than or equal to 2 meters). Other ranges are also possible.

In certain embodiments wherein the separation zone is configured as a tube, column, and/or cylinder, the separation zone may have any of a variety of suitable diameters. In certain embodiments, for example, the separation zone has a diameter greater than or equal to 1 centimeter, greater than or equal to 5 centimeters, greater than or equal to 10 centimeters, greater than or equal to 20 centimeters, or greater than or equal to 50 centimeters. In some embodiments, the separation zone has a diameter less than or equal to 1 meter, less than or equal to 50 centimeters, less than or equal to 20 centimeters, less than or equal to 10 centimeters, or less than or equal to 5 centimeters. Combinations of the above recited ranges are possible (e.g., the separation zone has a diameter greater than or equal to 1 centimeter and less than or equal to 1 meter, the separation zone has a diameter greater than or equal to 10 centimeters and less than or equal to 20 centimeters). Other ranges are also possible.

According to certain embodiments, the separation zone may be configured as a honeycomb structure. In some embodiments, for example, the separation zone may comprise a plurality of tubes, columns, and/or cylinders. In some such embodiments, each tube, column, and/or cylinder of the honeycomb separation zone may be fluidly connected to the gaseous species absorption zone such that each tube, column, and/or cylinder is configured to receive the gas stream after the gas stream has flowed through the gaseous species absorption zone. In certain embodiments wherein the separation zone is an electrostatic separation zone, each tube, column, and or cylinder of the honeycomb separation zone may comprise at least one emitter electrode and at least one collector electrode, as described herein. According to some embodiments, each tube, column, and/or cylinder of the honeycomb separation zone may have a length as described herein (e.g., greater than or equal to 10 centimeters and less than or equal to 5 meters) and/or a diameter as described herein (e.g., greater than or equal to 1 centimeter and less than or equal to 1 meter). Each tube, column, and/or cylinder of the honeycomb separation zone may, in some embodiments, have a comparatively smaller diameter than the tube, column, and/or cylinder of the gaseous separation zone.

The separation zone may comprise any of a variety of suitable materials. According to some embodiments, for example, the separation zone may comprise a metal, a metal alloy, a clad material, a ceramic, a plastic, a carbon-based material, and/or combinations thereof. Other materials are also possible. In certain embodiments, the separation zone material may be at least partially coated. For example, in some embodiments, the separation zone material is coated with a corrosion resistant material (e.g., a plastic coated with a corrosion resistant metal or alloy).

According to certain embodiments, a gas stream pressure drop along the gas flow pathway upstream of the gaseous species absorption zone (e.g., in the separation zone) is less than the overall gas stream pressure drop between the inlet of the gas flow pathway and the outlet of the gas flow pathway. Referring to FIG. 1, for example, a gas stream pressure drop along gas flow pathway 102 upstream of gaseous species absorption zone 110 (e.g., in separation zone 114) is less than the overall gas stream pressure drop between inlet 106 of gas flow pathway 102 and outlet 106 of gas flow pathway 102.

In some embodiments, the gas stream pressure drop along the gas flow pathway upstream of the gaseous species absorption zone (e.g., in the separation zone) is less than or equal to 50% less, less than or equal to 40% less, less than or equal to 30% less, less than or equal to 20% less, or less than or equal to 10% less than the overall gas stream pressure drop between the inlet of the gas flow pathway and the outlet of the gas flow pathway. In certain embodiments, the gas stream pressure drop along the gas flow pathway upstream of the gascous species absorption zone (e.g., in the separation zone) is greater than or equal to 1% less, greater than or equal to 10% less, greater than or equal to 20% less, greater than or equal to 30% less, or greater than or equal to 40% less than the overall gas stream pressure drop between the inlet of the gas flow pathway and the outlet of the gas flow pathway. Combinations of the above recited ranges are possible (e.g., the gas stream pressure drop along the gas flow pathway upstream of the gaseous species absorption zone is less than or equal to 50% less and greater than or equal to 1% less than the overall gas stream pressure drop between the inlet of the gas flow pathway and the outlet of the gas flow pathway, the gas stream pressure drop along the gas flow pathway upstream of the gascous species absorption zone is less than or equal to 30% less and greater than or equal to 20% less than the overall gas stream pressure drop between the inlet of the gas flow pathway and the outlet of the gas flow pathway. Other ranges are also possible. In certain embodiments, the gas stream pressure drop along the gas flow pathway upstream of the gascous absorption zone may be determined by measuring the difference in the pressure of the gas stream between an outlet of the gascous species absorption zone and the outlet of the gas flow pathway.

According to some embodiments, the system for removing a gaseous species from a gas stream may comprise any of a variety of additional components.

In certain embodiments, the system may comprise a fluidic connector positioned between the gaseous species absorption zone and the separation zone. FIG. 2 shows, according to some embodiments, a schematic diagram of system 100b for removing a gaseous species from gas stream 104, wherein system 100b comprises fluidic connector 120a positioned along gas flow pathway 102 between gascous species absorption zone 110 and separation zone 114. In some embodiments, it may be advantageous to position the fluidic connector between the gaseous species absorption zone and the separation zone to concentrate the gas stream (and, in some embodiments, the liquid mist entrained therein) prior to flowing the gas stream to the separation zone. Concentrating the gas stream (and, in some embodiments, the liquid mist entrained therein) may, in certain embodiments, increase the interfacial surface area between the liquid mist and the gas stream and/or the time of exposure between the liquid mist and the gas stream.

The fluidic connector may be configured as a tube, column, and/or cylinder, according to certain embodiments. Configuring the fluidic connector as a tube and/or column may advantageously facilitate the flow of the gas stream along the gas flow pathway through the fluidic connector. Other configurations for the fluidic connector are also possible, however, as the disclosure is not meant to be limiting in this regard, including, for example, a cube, prism, and/or cone configuration.

Although FIG. 2 shows that the fluidic connector is configured in a straight direction, the fluidic connector may have other directional configurations, as the disclosure is not meant to be limiting in this regard. In certain embodiments, for example, the fluidic connector may be configured with any of a variety of directional turns and/or curves.

The fluidic connector may, in some embodiments, have any of a variety of suitable dimensions. Referring to FIG. 2, for example, fluidic connector 120a has length 124c.

The fluidic connector may have any of a variety of suitable lengths. In some embodiments, for example, the length of the fluidic connector is greater than or equal to 1 centimeter, greater than or equal to 5 centimeters, greater than or equal to 10 centimeters, greater than or equal to 50 centimeters, or greater than or equal to 1 meter. In certain embodiments, the length of the fluidic connector is less than or equal to 2 meters, less than or equal to 1 meter, less than or equal to 50 centimeters, less than or equal to 10 centimeters, or less than or equal to 5 centimeters. Combinations of the above recited ranges are possible (e.g., the length of the fluidic connector is greater than or equal to 1 centimeter and less than or equal to 2 meters, the length of the fluidic connector is greater than or equal to 10 centimeters and less than or equal to 50 centimeters). Other ranges are also possible.

The fluidic connector may comprise any of a variety of suitable materials. According to some embodiments, for example, the fluidic connector may comprise a metal, a metal alloy, a clad material, a ceramic, a plastic, a carbon-based material, and/or combinations thereof. Other materials are also possible. In certain embodiments, the fluidic connector material may be at least partially coated. For example, in some embodiments, the fluidic connector material is coated with a corrosion resistant material (e.g., a plastic coated with a corrosion resistant metal or alloy).

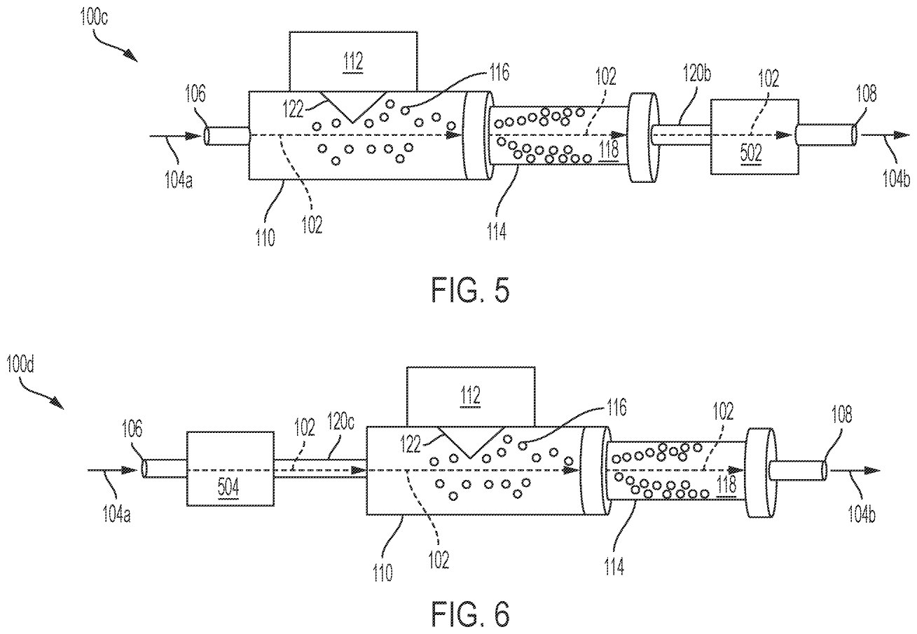

In certain embodiments, the system may comprise a gaseous species sensor. FIG. 5 shows, according to some embodiments, a schematic diagram of system 100c for removing a gaseous species from a gas stream, wherein the system comprise gaseous species sensor 502. According to some embodiments, gaseous species sensor 502 may be fluidly connected to (and upstream from) separation zone 114. In some embodiments, and as shown in FIG. 5, gaseous species sensor 502 may be fluidly connected to separation zone 114 via fluidic connector 120b. Gaseous species sensor 502 may, in certain embodiments, be configured to detect the amount of a gaseous species in the gas stream as the gas stream flows along gas flow pathway upstream 102 from separation zone 114. In some embodiments, gascous species sensor 502 is fluidly connected to (and downstream from) outlet 108.

In certain embodiments, the gaseous species sensor may be a spectroscopic sensor, such as, for example, an infrared sensor (e.g., an infrared CO₂ sensor). Other gaseous species sensors are also possible, however, as the disclosure is not meant to be limiting in this regard.

According to some embodiments, the system may comprise a scrubber. FIG. 6 shows, according to some embodiments, a schematic diagram of system 100d for removing a gaseous species from a gas stream, wherein the system comprises scrubber 504. According to some embodiments, scrubber 504 may be fluidly connected to (and upstream from) inlet 106 of gas flow pathway 102. Scrubber 502 may, in some embodiments, be configured to scrub one or more non-target species (e.g., non-target gaseous species) in the gas stream prior to the gas stream entering gaseous species separation zone 110. In certain embodiments, scrubber 504 may be fluidly connected to (and downstream from) gaseous species separation zone 110. According to some embodiments, and as shown in FIG. 6, scrubber 504 is fluidly connected to gaseous species separation zone 110 via fluidic connector 120c.

Any of a variety of suitable non-target species may be removed from the gas stream by the scrubber. In some embodiments, for example, the scrubber is configured to remove CO₂, sulfur oxide (SOₓ) species, nitrogen oxide species (NOₓ), hydrogen sulfide (H₂S), and/or combinations thereof. Other gases to be removed from the gas stream by the scubber are also possible.

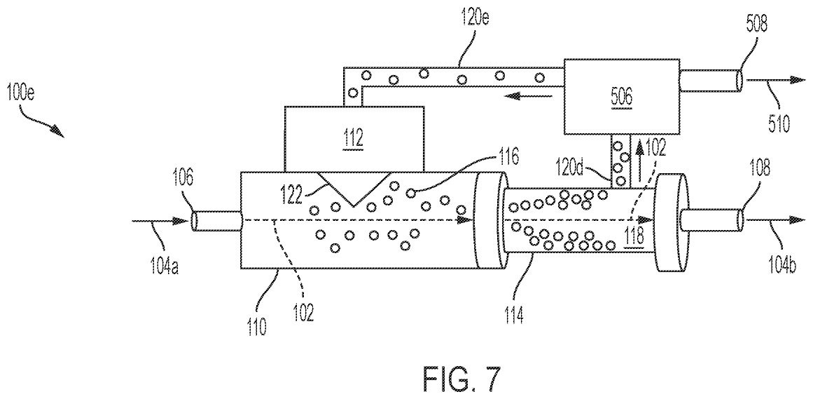

In some embodiments, the system may comprise a stripper. FIG. 7 shows, according to some embodiments, a schematic diagram of system 100ₑ for removing a gaseous species from a gas stream, wherein the system comprises stripper 506. According to certain embodiments, stripper 506 may be fluidly connected to (and upstream from) separation zone 114. In some embodiments, and as shown in FIG. 7, stripper 506 is fluidly connected to separation zone 114 via fluidic connector 120d. Stripper 506 may, in certain embodiments, be configured to strip the one or more absorbed gaseous species from absorbent 116 (e.g., in the form of liquid mist) after separating the absorbent from the gas stream in separation zone 114. Stripper 506 may, in some embodiments, be fluidly connected to (and downstream from) source of liquid mist 112. In certain embodiments, as shown in FIG. 7, stripper 506 is fluidly connected to source of liquid mist via fluidic connector 120e. According to some embodiments, after stripping the one or more absorbed gaseous species from absorbent 116, stripper 506 is configured to flow absorbent 116 to source of liquid mist 112. Configuring the system in this way advantageously allows the absorbent to be recycled and reused for additional absorption of gaseous species from gas streams.

According to certain embodiments, stripper 506 may be associated with stripper outlet 508 for releasing the gascous species stream 510 after stripping the gaseous species from absorbent 116.

The system may comprise additional components not shown in the figures, according to some embodiments. As would be recognizable by a person of ordinary skill in the art, the system may, in some embodiments, comprise one or more flow meters and/or pressure sources configured to control the flow rate of the gas stream through the system and/or the overall pressure of one or more components of the system (e.g., the gaseous species absorption zone and/or the separation zone). The system may, in some embodiments, comprise one or more pressure sensors and/or gauges configured to measure the pressure of the gas stream in the gas flow pathway. In certain embodiments, the system may comprise one or more fans and/or blowers configured to facilitate the flow of the gas stream through the system (e.g., along the gas flow pathway). According to some embodiments, the system may comprise one or more temperature controllers and associated connections to control the overall temperature of the system.

The system may have any of a variety of suitable overall lengths. Referring to FIG. 1, for example, system 100a has length 124d, which may, in some embodiments, be measured from inlet 106 of gas flow pathway 102 to outlet 108 of gas flow pathway 102. In some embodiments, the overall length of the system is greater than or equal to 20 centimeters, greater than or equal to 50 centimeters, greater than or equal to 1 meter, greater than or equal to 5 meters, greater than or equal to 10 meters, greater than or equal to 20 meters, or greater than or equal to 30 meters. In certain embodiments, the overall length of the system is less than or equal to 40 meters, less than or equal to 30 meters, less than or equal to 20 meters, less than or equal to 10 meters, less than or equal to 5 meters, less than or equal to 1 meter, or less than or equal to 50 centimeters. Combinations of the above recited ranges are possible (e.g., the overall length of the system is greater than or equal to 20 centimeters and less than or equal to 40 meters, the overall length of the system is greater than or equal to 1 meter and less than or equal to 5 meters). Other ranges are also possible.

The gas stream may be any of a variety of suitable gas streams. In some embodiments, for example, the gas stream is a combustion exhaust stream (e.g., flue gas, exhaust gas, stack gas) that, for example, emanates from a combustion plant. In certain embodiments, the gas stream is an industrial exhaust stream (e.g., a cement production exhaust stream). In certain embodiments, the gas stream is air. Other gas streams are also possible.

The gaseous species may be any of a variety of suitable gaseous species. In some embodiments, the gaseous species is a gaseous exhaust species. For example, in some embodiments, the gaseous species is a gaseous exhaust species present in a combustion exhaust stream and/or an industrial exhaust stream. In certain embodiments, the gaseous species a greenhouse gas. Examples of greenhouse gases include, but are not limited to, CO₂, CH₄, N₂O, O₃, fluorinated gases, and/or combinations thereof. Other gaseous species are also possible.

According to certain embodiments, a method of removing a gaseous species from a gas stream is described. In some embodiments, the method comprises exposing the gas stream containing the gaseous species to an absorbent (e.g., in the form of a liquid mist), wherein the absorbent comprises a reactant configured to dissolve and/or react with the gaseous species, as described herein.

In certain embodiments, the method comprises, in a gaseous species absorption zone, carrying out a reaction between the reactant and the gaseous species that results in absorption of the gaseous species from the gas stream by the absorbent (e.g., in the form of liquid mist).

The absorbent (e.g., in the form of liquid mist) may be configured to absorb any of a variety of suitable amounts of the gaseous species from the gas stream. In certain embodiments, for example, the absorbent is configured to absorb at least 10%, at least 20%, at least 30%, at least 40%, at least 50%, at least 60%, at least 70%, at least 80%, or at least 90% of the gaseous species from the gas stream. In some embodiments, the absorbent is configured to absorb less than or equal to 100%, less than or equal to 90%, less than or equal to 80%, less than or equal to 70%, less than or equal to 60%, less than or equal to 50%, less than or equal to 40%, less than or equal to 30%, or less than or equal to 20% of the gaseous species from the gas stream. Combinations of the above recited ranges are possible (e.g., the absorbent is configured to absorb at least 10% and less than or equal to 100% of the gascous species from the gas stream, the absorbent is configured to absorb at least 50% and less than or equal to 60% of the gaseous species from the gas stream). Other ranges are also possible.

According to certain embodiments, a ratio of a molar amount of the gaseous species absorbed by the absorbent per hour to a volume of the gaseous species absorption zone is at least 2 times greater, least 5 times greater, at least 10 times greater, at least 25 times greater, at least 50 times greater, at least 75 times greater, at least 100 times greater, at least 125 times greater, at least 150 times greater, or at least 175 times greater than a comparative ratio in an absorption tower comprising one or more packed bed reactors that is otherwise essentially identical. In some embodiments, the ratio of the molar amount of the gaseous species absorbed by the absorbent per hour to a volume of the gaseous species absorption zone is less than or equal to 200 times greater, less than or equal to 175 times greater, less than or equal to 150 times greater, less than or equal to 125 times greater, less than or equal to 100 times greater, less than or equal to 75 times greater, less than or equal to 50 times greater, less than or equal to 25 times greater, less than or equal to 10 times greater, or less than or equal to 5 times greater than a comparative ratio in an absorption tower comprising one or more packed bed reactors that is otherwise essentially identical. Combinations of the above recited ranges are possible (e.g., the ratio of the molar amount of the gaseous species absorbed by the absorbent per hour to a volume of the gascous species absorption zone is at least 2 times greater and less than or equal to 200 times greater than a comparative ratio in an absorption tower comprising one or more packed bed reactors that is otherwise essentially identical, the ratio of the molar amount of the gaseous species absorbed by the absorbent per hour to a volume of the gaseous species absorption zone is at least 75 times greater and less than or equal to 100 times greater than a comparative ratio in an absorption tower comprising one or more packed bed reactors that is otherwise essentially identical). Other ranges are also possible.

According to certain embodiments, the method comprises, in a separation zone fluidly connected to the gaseous absorption zone, separating at least some of the liquid mist from the gas stream.

These and other embodiments can be utilized alone or in combination with the benefit of additional factors, components, and/or procedures, as would be understood by those of ordinary skill in the art.

### Example 1

The following example describes a first embodiment of a two-stage, mist-based absorption system for removing a gaseous species from a gas stream.

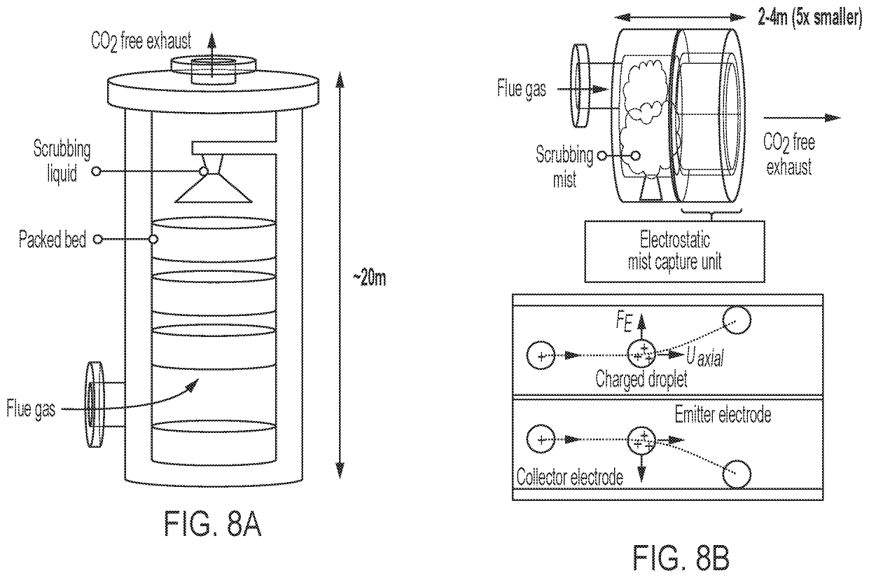

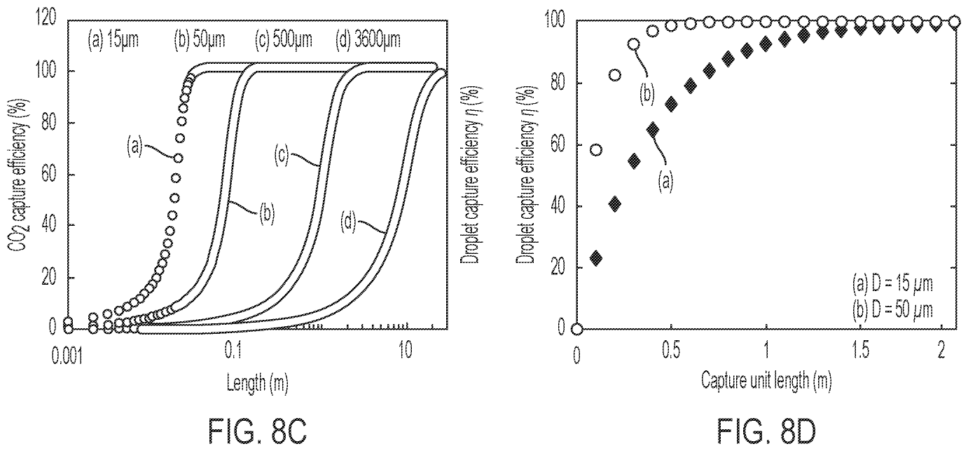

Conventional absorption systems use tall towers (10-20 meters in height) and packed beds to enhance the interfacial area and the residence time of the scrubbing liquid and the flue gas during absorption (see, for example FIG. 8A). Misting the scrubbing fluid would allow for significantly shorter absorbers due to higher interfacial areas afforded by small droplets, however such mists are difficult to capture and recycle using passive demisters. An active electrostatic demister can capture these mists without imposing significant back pressures.

To this end, a two-stage, mist-based absorption system (shown in FIG. 8B) is described herein. In the first stage, the absorption stage, mist-scale droplets with diameters between 15 and 50 μm were used, which allowed the system to achieve up to a 280-fold increase to the interfacial area available between the absorbent and the gas as compared to conventional packed bed reactors. While this allowed for absorber units that are significantly shorter than conventional systems, droplets of this size were easily entrained by the gas flow. To capture this large liquid volume, a second stage, the electrostatic droplet capture stage, was utilized. Specifically, by employing a corona discharge, the mist-scale droplets were charged, and an electrical force was introduced that drives the charged mist-scale droplets to a collector where the liquid absorbent was collected, processed, and recirculated.

To better understand the ability of the system to reduce the overall size of absorbers, the lengths required for both stages of the system were theoretically estimated. CO₂ absorption into droplets of different radii was modeled using the empirical model shown in Equation 2.

$$\frac{{\dot{m}}_{{CO}_{2 , j}}}{A} = {k}^{0.48} {C}_{g , s , j} {C}_{l , j} [ \frac{2.15 \times 1 {0}^{- 6}}{{C}_{l , i}^{0.5}} + \frac{1.4 \times 1 {0}^{- 7}}{{D}^{0.3}} {( 1 - \frac{{C}_{l , j}}{{C}_{l , i}} )}^{2.5} ] \qquad ( Eq . 2 )$$

In Equation 2, \dot{m}_{CO}_{₂} is the mass flux of CO₂ into the droplet, A is the droplet area, k is the reaction rate, C represents concentration, and D is the droplet diameter. The subscripts, g and l represent the CO₂ and the sorbent, respectively. The subscripts s and i represent the surface of the droplet and the inlet, respectively, and j is an iteration counter. Since the benefits afforded by the system are agnostic of the specific absorbent chemistry, ammonia was utilized as a model absorbent. Using a gas flow velocity of 3 m/s, an inlet CO₂ concentration of 15%, and an ammonia concentration of 15 wt. %, the CO₂ absorbed by a single droplet was estimated from its sphere of influence as a function of droplet travel distance. A liquid-to-gas mass flow ratio of 1:1 was used to define the control volume that follows an individual droplet as it travels with the gas flow. Using this framework, the benefit afforded by this system was examined for droplets of different sizes. Since absorbent films in conventional packed bed reactors are typically 600-700 μm thick, the interfacial area offered by packing units with a droplet diameter of 3600 μm was replicated for a given volume of liquid. It was observed that such large droplets would also require absorber towers that are >20 m tall, confirming the role of interfacial area in absorption. In contrast, when droplet diameters of 50 μm and 15 μm were employed, the required lengths for >95% CO₂ absorption reduced significantly. In practice, the length of the absorption stage will be larger than the dimensions predicted by the single drop model presented in FIG. 8C, as the model does not account for droplet-droplet interactions, local concentration gradients, and for the practical constraints of introducing up to 800 kg/s of absorbent into a flue gas stream. The model does show, however, that drastic reductions to absorber dimensions are possible by transitioning to mist-scale droplets.

For the second stage of the system, the maximum length required to capture >95% of the mist droplets was also estimated. Considering the cylindrical design of the electrostatic collector shown in FIG. 8B, the electrostatic force that a charged droplet would experience was compared with the aerodynamic drag force. The characteristic radial velocity (Uᵣ) of a mist-scale droplet was estimated, as shown in Equation 3. Using the Deutsch-Anderson equation (Equation 4), the droplet collection efficiency (η) was then estimated as a function of cylinder length (L_{c}), diameter (D_{c}), and gas flow rate (Q), as shown in FIG. 8D.

$${U}_{r} ∼ \frac{qE}{6 πμ R} = \frac{4 π {R}^{2} {ε}_{0} {E}^{2}}{6 πμ R} = \frac{2 R {ε}_{0} {E}^{2}}{3 μ} \qquad ( Eq . 3 )$$

$$η = 1 - {e}^{( - \frac{{U}_{r} {A}_{c}}{Q} )} = 1 - {e}^{( - \frac{{U}_{r} π {D}_{c} {L}_{c}}{{C}_{DA} Q} )} \qquad ( Eq . 4 )$$

In the above equations, q represents the charge accumulated on a single droplet, E represents the electric field strength, μ is the viscosity of the flue gas, R is the droplet radius, ε₀ is the permittivity of free space, and C_{DA} is the correction factor to the Deutsch-Anderson equation used for practical systems.

From FIGS. 8C and 8D, it was observed that the overall length of the absorber unit could be reduced from around approximately 20 meters in conventional packed bed reactors for a 400 MW power plant to less than 4 meters in the two-stage system discussed herein. This would enable a drastic reduction to the capital required for CO₂ absorber units. To validate these models, a scaled down version of the two-stage system was developed and tested. For the first stage of the system, the gas flux of industrial absorber units was matched, and the effect of input CO₂ and catalyst concentration on CO₂ capture efficiency was studied. For the second stage, the droplet capture efficiency of a scaled down electrostatic system was explored as a function of gas flow rate and electric field strength. An economic analysis is also presented to capture the reduction to plant capital expenditure that could be enabled by the two-stage, mist-based absorption system.

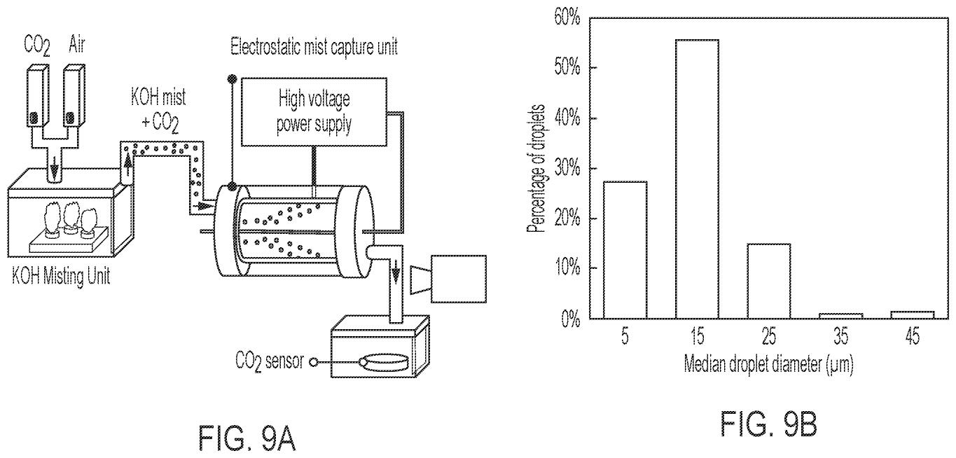

Experimental setup: FIG. 9A presents an illustration of the experimental setup used in this example. Flow controlled CO₂ and air streams were mixed to achieve desired concentrations of CO₂ at the inlet to the system. The gas was then introduced to a misting unit where droplets were entrained into the gas flow. Potassium hydroxide was used as the absorbent due to experimental simplicity. The gas and the entrained mist then flowed through a fixed length of piping to allow time for absorption of CO₂. The mist laden gas mixture was then flowed into the electrostatic demister capture unit where all the absorbent drops were removed. An infrared CO₂ sensor was used to quantify the CO₂ captured in the system. FIG. 9B shows a histogram of droplet diameters produced by the misting unit, indicating that a majority of the droplets fall within a diameter range of 10-20 μm. This histogram was obtained by visually recording the mist droplets as they passed through the viewing window when the electrostatic droplet capture unit was turned off. This provided an accurate representation of the droplets that were being entrained by the gas flow.

Gas mixing and mist generation: Brooks® mechanical flow meters were used to control the flow rates of the CO₂ and air before the two gas streams were mixed using a T-junction. The mixed gas was introduced into the headspace of an air-tight container that contained a bath of the absorbent and an ultrasonic misting unit (Mxmoonant® 6 Head Ultrasonic Mist/Fog maker). The experiments were started with the misting unit and the mist capture units turned off. The initial concentration of CO₂ was recorded after the gas flowed through the headspace of the air-tight container so that any effects of the bath of absorbent were considered in the control measurement. When the ultrasonic mister was turned on, mist scale droplets were ejected into the headspace of the air-tight container and subsequently entrained by the gas flow.

CO₂ sensor: CO₂ concentrations were measured using a GC-0007 ExplorIR® sensor. The sensor was placed in line with the gas stream in a vented container.

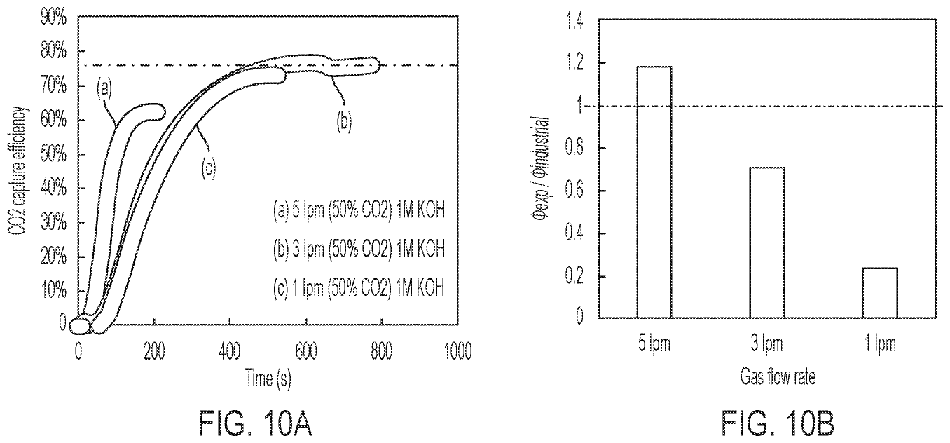

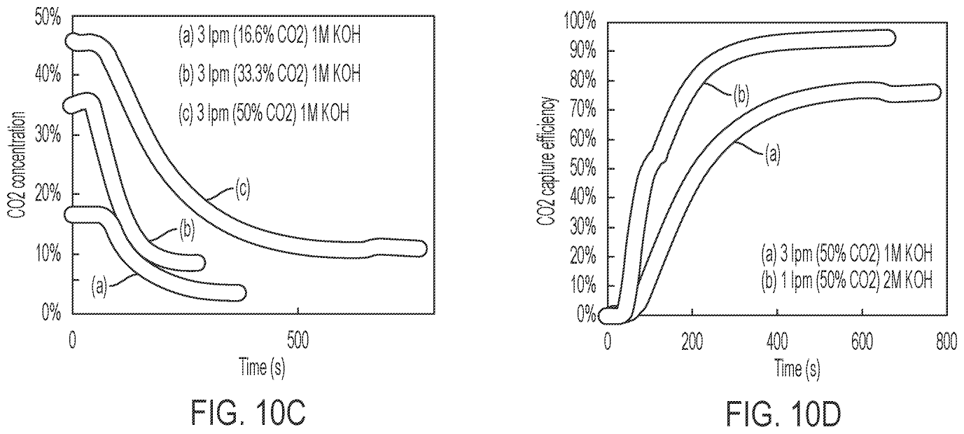

Absorption stage: To appropriately scale down the experimental absorber, the flow rate of the inlet gas was varied between 1 and 5 1 pm while keeping the CO₂ concentration constant at 50%. FIG. 10A shows the CO₂ capture efficiency of the system for these experiments. It was observed that while the capture efficiency reached ˜74±5% for the flowrates of 1 and 3 1 pm, it dropped down to about 64±5% for the 5 1 pm case, indicating that the liquid-to-gas ratio and the residence time are too low for the scrubbing to be maximally effective. To further characterize this reduction in performance, the gas flux through the experimental setup was normalized by the flux achieved in industrial absorption systems, as industrial absorber systems are designed to optimize the gas flux to achieve the maximum capture efficiency possible. In FIG. 10B, the ratio of the experimental and the industrial gas fluxes (in kg/m²s) was determined, and it was found that the case of 5 1 pm has an unfavorable flux ratio which could explain the drop-in performance, as the flow rate of the gas is too high to optimize CO₂ capture.

Setting the flow rate to 3 1 pm, to stay in a favorable flux regime for the remaining absorption experiments, the input CO₂ concentration was varied from approximately 17% to 50%, as shown in FIG. 10C. In these cases, a capture efficiency of approximately 70±5% was observed, which is consistent with industrial KOH-based absorption units. The liquid-to-gas mass flow ratio (L/G) was measured to be approximately 21±4 for a gas flow rate of 3 1 pm, and this value is also of the same order as industrial and other conventional systems. The capture efficiencies of >70% demonstrate the ability of this technique to be robust to input CO₂ concentrations and demonstrates that, at these conditions, the capture efficiency is limited by absorbent chemistry.

Equation 5 shows the stoichiometric reaction between KOH and CO₂. In the experimental setup, at a gas flow rate of 3 1 pm, the molar flow rates of KOH and CO₂ are 1.7 and 1.1 milli-moles per second, respectively. Since two moles of KOH are needed to react with every mole of CO₂, the stoichiometric capture efficiency is 76%. To validate that the 74±5% experimental capture efficiency observed is indeed limited by the chemical concentration of the absorbent, the KOH concentration was increased from 1 M to 2 M and it was observed that the CO₂ capture efficiency increased to 95±5% for the case of a 3 1 pm gas flow rate and a 50% inlet CO₂ concentration (FIG. 10D). These results illustrate the promise of the mist-based absorption system, especially in terms of enabling a wider range of absorbents that could have a better environmental and safety profile than the alcoholic amines that are currently preferred in conventional absorber units.

$$2 KOH + {CO}_{2} \to {K}_{2} {CO}_{3} + {H}_{2} O \qquad ( Eq . 5 )$$

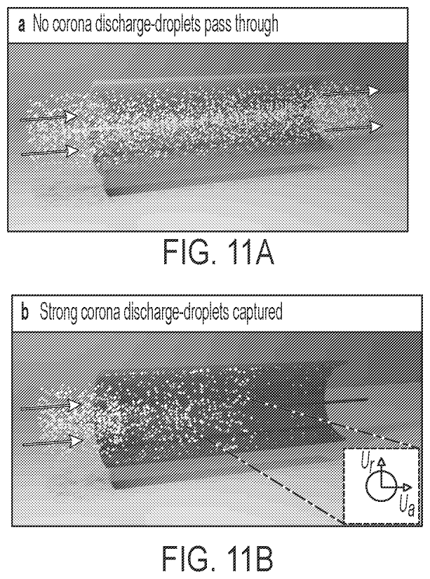

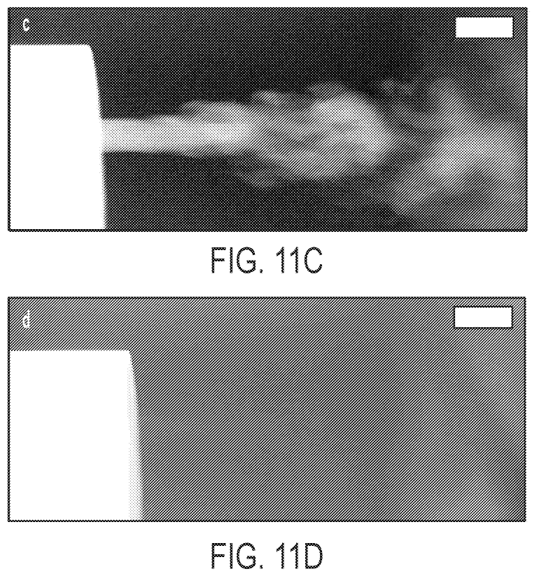

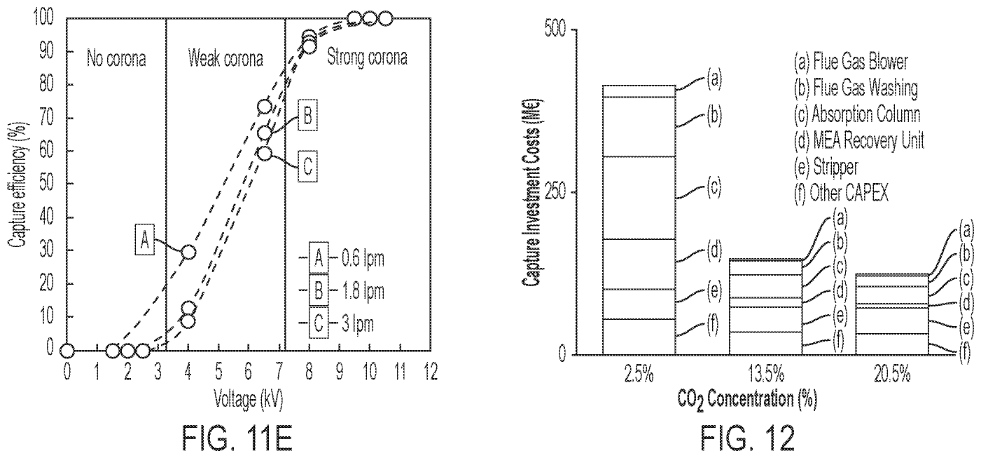

Mist droplet capture stage: Having demonstrated the ability of mist-scaled droplets to achieve CO₂ capture efficiencies >70%, the ability of the scaled down electrostatic unit to capture the mist droplets was explored. FIGS. 11A and 11B show conceptual schematics of the mist capture unit when there is no corona discharge and when there is a stronger discharge, respectively. FIGS. 11C and 11D show digital photographs of the exit of the demisting unit under no corona and strong corona conditions, respectively, visually illustrating the ability of the scaled-down demister to completely capture mist for a gas flow rate of 3 1 pm and a voltage of approximately 8 kV. When the voltage source is off, mist exists the misting unit as it is entrained by the gas flow, but when the emitter electrode produces a strong corona discharge, all the mist is captured. FIG. 11E shows the mist capture efficiency as a function of gas flow rate and applied voltage. When the voltage was not high enough to generate a corona discharge, the droplets were not charged and therefore did not get collected. As the voltage was increased, the corona onset voltage was passed, and the droplets began to be collected. In this state, the concentration of free ions in the gas stream was not high enough to charge all the mist-scale droplets that were entrained and therefore only partial capture was achieved. In the region of strong corona, 100% capture was achieved as nearly all the droplets became charged and were transported to the grounded collector. The electric field strength applied in the scaled down system was about 2 kV/cm, which is well within the field strength used in scaled-up electrostatic precipitation systems, indicating the practical promise of the two-stage, mist-based absorption system.

Economic analysis of a scaled-up absorber unit: When the two-stage, mist-based absorber is appropriately scaled down, CO₂ capture efficiencies between 70-95% are achieved and all the mist droplets are captured effectively. To assess the economic feasibility of the two-stage, mist-based approach, the required CAPEX to install the system was estimated and compared to the CAPEX required for a conventional vertical packed bed absorber tower. For the conventional vertical packed bed architecture, two absorber towers of heights 19.06 m and diameters of 11.93 m were chosen from an optimized MEA CO₂ capture system for a 400 MW gas-fired power plant with a flue gas rate of 622 kg/s. Purchase costs of the absorber tower housing and the internal components were estimated from average historical data and subsequently adjusted via the Chemical Engineering Plant Cost Index (CEPCI) to 2019 USD. A typical Lang Factor of 4.74 was applied to yield the estimated installed cost of the system components tabulated in Table 1.

The estimated total CAPEX for the packed bed system is $149 M. As expected, the stainless steel-clad carbon steel absorber tower is a key cost driver, accounting for over 50% of the cost. To estimate an analogous CAPEX for the two-stage, mist-based absorption system, the same flue gas flow rate and absorber unit housing diameter were used as in the previous case. By leveraging the enhanced absorption kinetics of mists, the absorber housing unit length can be reduced by a factor of 5×, as previously described. Moreover, it can be installed in a horizontal configuration as it no longer uses gravity-driven flows, thereby reducing installation cost factors. The costs of the electrostatic mist capture unit are derived from historical costs and installation factors, scaled for capacity, and adjusted with the CEPCI index. At a CAPEX of $57.3M, the two-stage, mist-based absorption system offers a ˜2.6×reduction in capital cost compared to conventional packed bed absorption towers. These savings are due to the elimination of the packed beds in addition to a reduction in absorber unit housing costs associated with smaller total dimensions.

TABLE 1
CO₂ absorption CAPEX estimates for a 400 MW gas fired coal
plant for conventional vertical packed-bed architectures
compared to the two-stage, mist-based absorption system.

| | | |
|---|---|---|
| | Packed Bed | Mist Capture |
| | Architecture Cost | Architecture Cost |
| Subsystem Description | ($USD M) | ($USD M) |

Absorber unit - CAPEX

| | | |
|---|---|---|
| Absorber unit housing | 81.3 | 9.0 |
| Packed bed | 57.9 | — |
| Liquid nozzles | 4.9 | 3.8 |
| Pressure pumps | 2.8 | 3.4 |

Mist capture system - CAPEX

| | | |
|---|---|---|
| Passive de-misting | 2.5 | — |
| Space charge capture | — | 42.6 |
| Total CAPEX | 149.4 | 57.3 |

In conclusion, a simple and efficient proof-of-concept absorber system to capture CO₂ using mist-scale droplets has been demonstrated. Using a scaled down experimental setup that matches the gas flux and L/G ratios of other industrial and experimental post combustion carbon capture systems, CO₂ capture efficiencies up to 95% were achieved using potassium hydroxide as the absorbent. The ability of the electrostatic droplet capture unit to collect >95% of the entrained droplets at an electric field strength that is consistent with industrial systems has also been demonstrated. In addition, chemical engineering plant economic models were used to estimate that a scaled-up installation of the two-stage, mist-based absorption system could reduce CO₂ absorber costs by a factor of 2.6.

### Example 2

The following example describes a second embodiment of a two-stage, mist-based absorption system for removing a gaseous species from a gas stream.

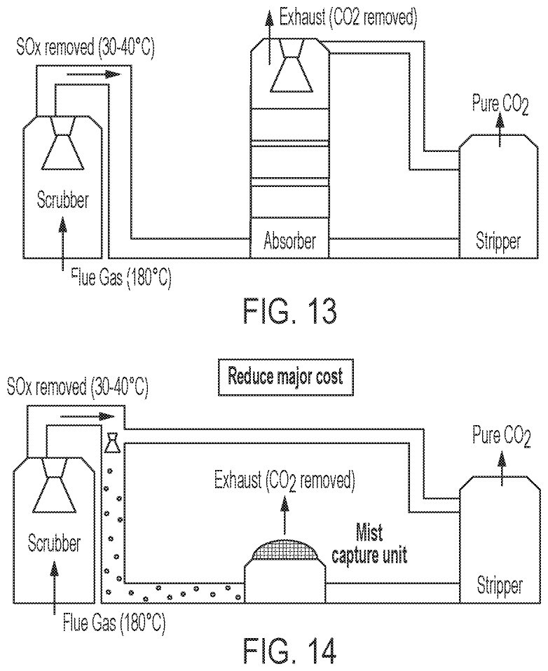

In conventional absorption systems, one or more absorption towers allow for the interaction between a CO₂-containing flue gas and a sorbent liquid (typically 30% wt. of MEA in water). At the exhaust of the absorption tower, more than 90% of CO₂ is removed from the flue gas and the CO₂ rich amine solution is sent to a stripper column to separate CO₂ from the amine, as shown in FIG. 13. As described herein, the need for such absorption towers can be eliminated, thereby cutting down a major portion of the capital expenditure and associated operating costs, by introducing an absorbent liquid in the form of tiny mist droplets that are later captured via electrostatic space charge injection.

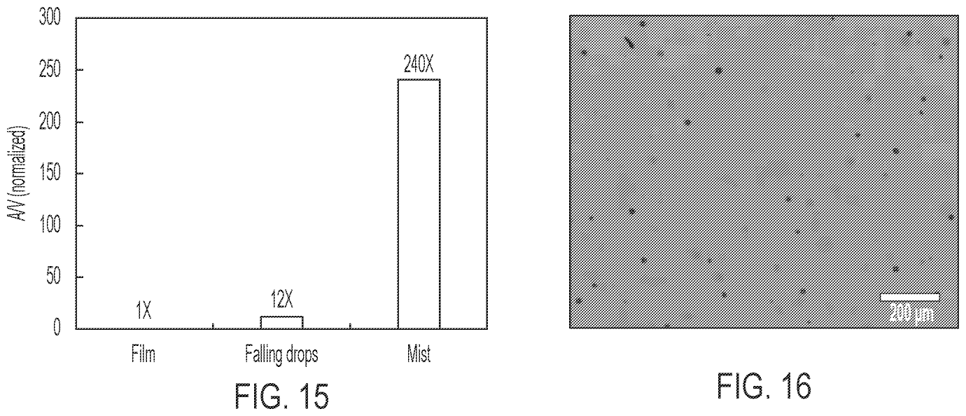

In the two-stage, mist-based absorption system described herein, the absorbent liquid is introduced as a mist into the flue gas upstream of where the flue gas exits a SOₓ scrubber, at 30-40° Celsius, as shown in FIG. 14. This maximizes the interfacial area of the interaction between the amine solution and the flue gas because of the enhanced surface area for the same volume flow rate of liquid due to the tiny mist droplets. Compared to conventional packed bed absorption towers or spray towers, the mist droplets dramatically increase the total surface area for CO₂ absorption, as shown in FIG. 15, which makes the reaction kinetics much faster and eliminates the need for such towers.

It is difficult to efficiently capture the CO₂ because the tiny mist droplets can easily entrain along with the flow of the flue gas and escape at the flue gas exit. Conventional mist collector systems are inefficient, and increasing the mist collection efficiency by tightly packed mechanical components also significantly increases the back pressure in the flue gas stream. The two-stage, mist-based system utilizes a space charge injection for efficient collection of the mist. The comparatively smaller electrostatically driven space charge injection unit for mist collection replaces the absorption tower in conventional systems, as shown in FIG. 14.

The interaction parameter that governs the rate of CO₂ absorption is dictated by the interfacial area and time of interaction between flue gas and absorbent liquid. In the case of absorption towers, for a given volume flow rate of liquid, the area is increased by using a packed bed. The film thickness of liquid flowing over the packed bed, however, is on the order of hundreds of micrometers. Therefore, to maximize the interaction parameters, the interaction time is increased by increasing the height of the tower. In contrast, the two-stage, mist-based system utilizes liquid droplets in the form of mist with sizes on the order of ten micrometers. These droplets are so tiny that they can be entrained in the flue gas. By reducing the size of the droplets, the surface area of interaction was increased tremendously (for a given volume of liquid, FIG. 15) and thereby the time needed for CO₂ absorption reduced. Thus, instead of using tall absorption towers, the two-stage, mist-based system utilizes horizontal pipes for flue gas management to entrain mist and cause CO₂ absorption.

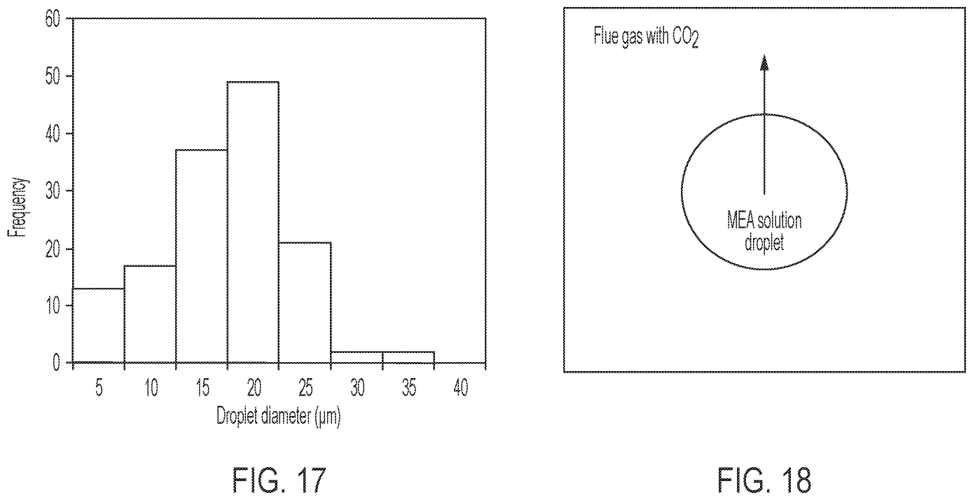

Mist production: High density mist was produced via various techniques. One of the most efficient ways to produce high density mist, however, was to utilize a mechanical ultrasonicator. The produced mist was entrained in the gas flow, due to the small size of the mist droplets, as shown in FIGS. 16 and 17.

CO₂ absorption: The produced mist was entrained along with a CO₂/air mixture. The mist droplets reacted quickly with the surrounding gas, thereby capturing CO₂, as depicted in FIG. 18.

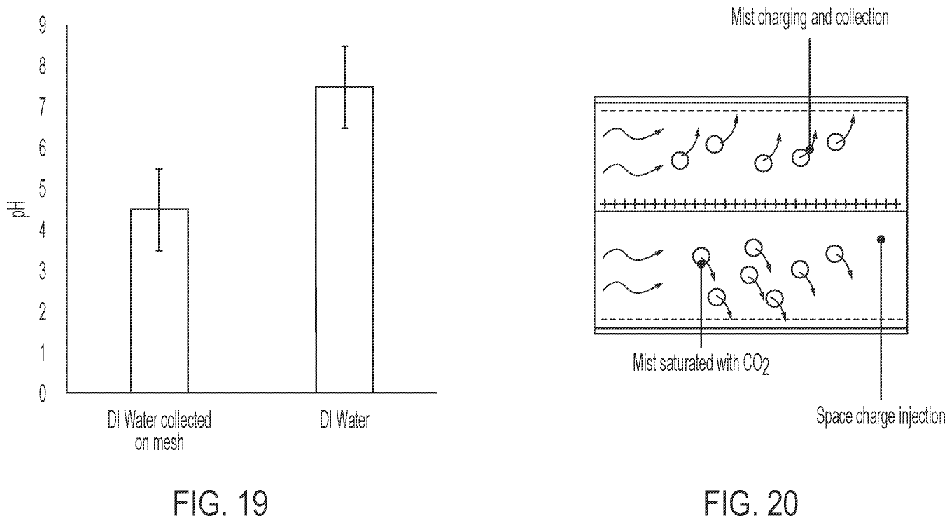

DI water was used to test the efficacy of the system. The DI water quickly saturated with CO₂. After collecting the mist droplets, the pH of the DI water saturated with CO₂ was measured and compared to the pH of neutral DI water, as shown in FIG. 19. It was observed that the pH dropped due to the formation of carbonic acid resulting from the dissolution of CO₂ in water.

Mist capture: Mist droplets that reacted with CO₂ in the flue gas were captured via a technique called space charge injection. Briefly, the space charge may be produced using a sharp emitter, such as an electrode that provides electric field concentration, with another electrode acting as the droplet collector. By applying a voltage between the emitter and collector electrodes, the air surrounding the emitter ionizes to produce an injection of space charge. The charged molecules then find the mist droplets flowing through the space between the electrodes and impart a net charge to the droplets. The charged droplets experience an electrostatic force in the direction of the electric field and thus get collected on the collector electrode, as shown in FIG. 20.

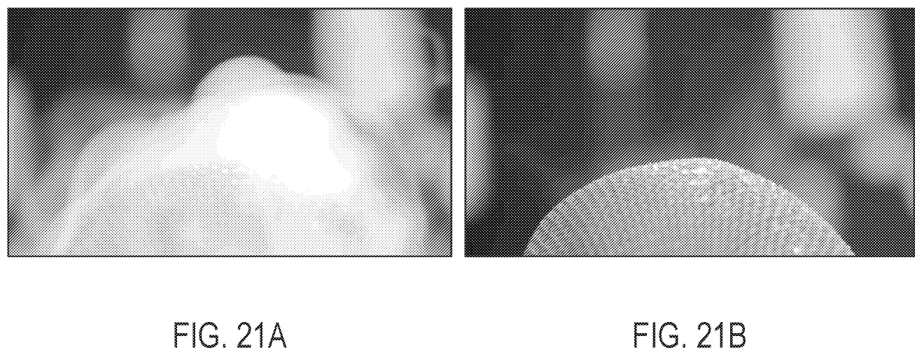

In one of the embodiments for mist capture, mesh-like collector electrodes were used. FIG. 21A shows the entrained mist droplets escaping along with the gas flow when the electric field was off. Entrainment is one of the most common modes of solution loss in conventional CO₂ capture systems. FIG. 21B shows the capture of mist on the collection mesh electrode when the electric field was on. Almost no mist droplets disappeared along with the gas flow. Instead, the droplets were charged by the injected space charge and the charged droplets were collected on the mesh.

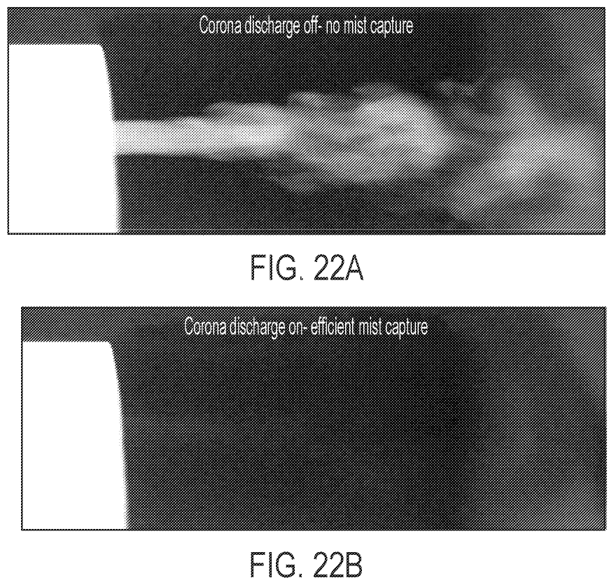

Another embodiment for the mist capture system was designed using a thin wire electrode as the emitter for charging the mist droplets and an annular cylindrical electrode as the collector. The efficient capture of mist was demonstrated, as shown in FIGS. 22A-22B.

Advantages and improvements over conventional methods, devices, and materials: The two-stage, mist-based system described herein enables complete elimination of CO2 absorption towers that contribute to up to 55% of the CAPEX of CO₂ capture units (FIG. 12). In many of the conventional absorption systems, the operating expense (OPEX) is closely linked with CAPEX because a big portion of OPEX arises from the absorption tower installation, which needs to be maintained. The two-stage, mist-based system reduces material cost and associated maintenance costs.

Increasing the interaction parameter of CO₂ means that the dependency on amines, which are considered extremely toxic, can also be reduced. The reaction rate of amines with CO₂, however, is comparatively higher than other environmentally benign chemicals. By increasing the CO₂ interaction area with the absorption solution, the two-stage, mist-based system opens the door to efficient usage of cheaper and greener chemicals for CO₂ capture, such as 2-amino-2-methyl-1-propanol (AMP) or KOH.

Finally, by reducing the carbon capture cost, the dependency of carbon capture on the price of fossil fuels is also reduced. Since enhanced oil recovery is one of the uses of captured and concentrated carbon, when the price of the recovered oil goes down, it becomes economically non-viable to capture CO₂. Therefore, at present, CO₂ capture systems are much more dependent on fossil fuel price.

Commercial applications: The CO₂ capture and storage systems market capitalization is about 2 billion USDs. There are only about 28 large scale commercial CO₂ capture facilities around the world, however, due to the prohibitive cost of installation and maintenance. By eliminating the absorption tower, the two-stage, mist-based system can reduce the capital expenditure of CO₂ capture systems by 30-55% and proportionally reduce the operating expenditure. Reducing the CO₂ capture cost will tremendously increase the market capitalization, because if CO₂ can be cheaply obtained to produce other value-added products, more power plants will be open for installation of CO₂ capture units.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of.” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of.” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A system for removing a gaseous species from a gas stream, comprising:
a gas flow pathway having an inlet for receiving the gas stream and an outlet for releasing the gas stream, wherein the gas stream contains less of the gaseous species at the outlet than is contained in the gas stream at the inlet;
a gaseous species absorption zone along the gas flow pathway;
a source of a liquid mist configured to introduce the liquid mist into the gaseous species absorption zone, wherein the gaseous species absorption zone is configured to expose the liquid mist to the gas stream under conditions that facilitate transfer of at least some of the gaseous species from the gas stream to the liquid mist; and
an electrostatic separation zone along the gas flow pathway, fluidly connected to the gaseous species absorption zone and configured to electrostatically separate at least some of the liquid mist from the gas stream.

2. The system of claim 1, wherein the liquid mist comprises a plurality of droplets, and wherein each droplet of the plurality of droplets has a maximum characteristic dimension less than or equal to 70 micrometers.

3. The system of claim 1, wherein the liquid mist comprises a plurality of droplets, and wherein each droplet of the plurality of droplets has a maximum characteristic dimension less than or equal to 20 micrometers.

4. The system of claim 1, wherein the electrostatic separation zone is configured to expose the gas stream comprising the liquid mist to a corona discharge.

5. The system of claim 1, wherein the electrostatic separation zone comprises a surface configured to absorb the liquid mist.

6. A system for removing a gaseous species from a gas stream, comprising:
a gas flow pathway having an inlet for receiving the gas stream and an outlet for releasing the gas stream, wherein the gas stream contains less of the gaseous species at the outlet than is contained in the gas stream at the inlet;
a gaseous species absorption zone along the gas flow pathway;
a source of a liquid mist configured to introduce the liquid mist into the gaseous species absorption zone, wherein the gaseous species absorption zone is configured to expose the liquid mist to the gas stream under conditions that facilitate transfer of at least some of the gaseous species from the gas stream to the liquid mist, wherein the liquid mist comprises a plurality of droplets, and wherein each droplet of the plurality of droplets has a maximum characteristic dimension less than or equal to 70 micrometers; and
a separation zone along the gas flow pathway, fluidly connected to the gaseous species absorption zone and configured to separate at least some of the liquid mist from the gas stream.

7. The system of claim 6, wherein each droplet of the plurality of droplets has a maximum characteristic dimension less than or equal to 20 micrometers.

8. The system of-any one of claims 6 7 claim 6, wherein the separation zone is an electrostatic separation zone configured to electrostatically separate at least some of the liquid mist from the gas stream.

9. The system of claim 8, wherein the electrostatic separation zone is configured to expose the gas stream comprising the liquid mist to a corona discharge.

10. The system of claim 6, wherein the separation zone comprises a surface configured to absorb the liquid mist.

11. A system for removing a gaseous species from a gas stream, comprising:
a gas flow pathway having an inlet for receiving the gas stream and an outlet for releasing the gas stream, wherein the gas stream contains less of the gaseous species at the outlet than is contained in the gas stream at the inlet;
a gaseous species absorption zone along the gas flow pathway; and
an absorbent associated with the gaseous species absorption zone, wherein the gaseous species absorption zone is configured to expose the absorbent to the gas stream under conditions that facilitate transfer of at least some of the gaseous species from the gas stream to the absorbent,
wherein an interfacial area between the absorbent and the gas stream is at least 10 times greater than an interfacial area between a comparative absorbent and a comparative gas stream in an absorption tower comprising a packed bed reactor that is otherwise essentially identical.

12. The system of claim 11, wherein the interfacial area between the absorbent and the gas stream is at least 400 times greater than the interfacial area between the comparative absorbent and the comparative gas stream in the absorption tower comprising the packed bed reactor that is otherwise essentially identical.

13. The system of claim 11, further comprising a separation zone along the gas flow pathway, fluidly connected to the gaseous species absorption zone and configured to separate at least some of the absorbent from the gas stream.

14. The system of claim 11, wherein the absorbent is in the form of a liquid mist.

15. The system of claim 14, wherein the liquid mist comprises a plurality of droplets, and wherein each droplet has a maximum characteristic dimension less than or equal to 70 micrometers.

16. The system of claim 1, wherein the gas stream is a combustion exhaust stream.

17. The system of claim 1, wherein the gaseous species is a gaseous exhaust species.

18. The system of claim 1, wherein the gaseous species is a greenhouse gas.

19. The system of claim 1, wherein the gaseous species is CO₂.

20. The system of claim 1, wherein the gas stream contains greater than or equal to 10% less of the gaseous species at the outlet than is contained in the gas stream at the inlet.

21. The system of claim 1, wherein the gas stream contains less than or equal to 80% less of the gaseous species at the outlet than is contained in the gas stream at the inlet.

22. The system of claim 1, wherein an overall gas stream pressure drop occurs between the inlet and the outlet of the gas flow pathway, and wherein a gas stream pressure drop along the gas flow pathway upstream of the gascous species absorption zone is less than 50% of the overall gas stream pressure drop.

23-34. (canceled)
